(19) United States
(12) Patent Application Publication
(10) Pub. No.: US 2005/0274076 A1
(43) Pub. Date: Dec. 15, 2005

(54) Sanitizing container and display

(76) Inventor: Ashkan Farhadi, Chicago, IL (US)

Correspondence Address: ASHKAN FARHADI, 1725 W. HARRISON, PROFESSIONAL BUILDING, STE. 206, RUSH PRESBYTERIAN MEDICAL CENTER, CHICAGO, IL, 60612, US

(21) Appl. No.: 10/857,114

(22) Filed: Jun. 1, 2004

(51) Int. Cl. A01G 9/02

(52) U.S. Cl. 47/66.6

(57) ABSTRACT

Sanitizing Container and Display is an assembly for maintaining and displaying potted plants, cut flowers and flower arrangements in hospitals, home or other environments where immunocompromised patients or those who suffer allergic disease live. This closed plant-holding container is provided with a air filtered ventilation system that establishes adequate air circulation to the plants while filters the chamber out-flow air and clear out any potential harmful microbe, dust, allergen or fumes from chamber out-flow air that would be dangerous for those patients who lacks normal immune protection or are allergic to plant and flower allergens. This enclosed chamber also is provided with an artificial light source for illumination of the plants or flowers. The object of this invention was to create a completely sealed chamber that makes it possible for immunsuppressed patients or those with sever allergic disease to enjoy the loveliness of these natural beauties in their living environment.

### CROSS-REFERENCE TO RELATED APPLICATION

| Patent | Issued | Inventor(s) | Applicant(s) | Title |
|---|---|---|---|---|
| U.S. Pat. No. 4597550 | July 1986 | Rice | None | Potted plant display stand |
| U.S. Pat. No. 3973356 | October 1976 | Schacht | None | Flower caddy |
| U.S. Pat. No. 5241781 | September 1993 | Malczyk | None | House plant hospital |
| U.S. Pat. No. 4858381 | October 1989 | Walton | Smithers-Oasis | Floral container and water |
| | | | Co. | reservoir |
| U.S. Pat. No. 4543744 | October 1985 | Royster | None | Plant growing chamber |
| U.S. Pat. No. 4850135 | July 1989 | DeMarco | None | Apparatus for stimulating plant |
| | | | | growth under controlled |
| | | | | condition |
| U.S. Pat. No. 4250666 | February 1981 | Rakestraw | None | Supporting structure for plants |
| U.S. Pat. No. 4198783 | April 1980 | Leroux | None | Hydroponic apparatus |
| 20020136669 | September 2002 | Marques | None | Air filtering apparatus and |
| | | | | method for using same |

### STATEMENT REGARDING FEDERALLY SPONSORED RESEARCH OR DEVELOPMENT

Not applicable.

### REFERENCE TO MICROFICHE APPENDIX

Not applicable

### FIELD OF INVENTION

The present invention relates to an enclosed apparatus for maintaining and displaying potted plants, cut flowers and flower arrangements in hospitals, home or other environments where immunocompromised or allergic patients live. This closed plant-holding container is provided with a ventilation system that establishes adequate air circulation to the plant while outflow air is filtered to clear any potential harmful microbes, allergens (small particles that cause allergy) or chemical fumes that would be dangerous for those patients who lack normal immune protection or are allergic to plant or flower allergens. This enclosed chamber also is provided with an artificial light source for illumination of the enclosed plants or flowers.

### BACKGROUND OF INVENTION

The world-wide rising number of severely immunocompromised patients and those who suffer allergic diseases has made the control and prevention of infections and allergic disorders a critical issue. There are several microbes and allergens in the natural habitat of human, which are not harmful in healthy individual but are potentially dangerous to that patient who lack normal immune protection or suffer from severe allergic disorders, respectively. Opportunistic infections are those infectious agents that could cause infection in those who lack normal immune system. Fungal infections and particularly Aspergillosis, one of important member of this group of infectious agents could cause life-threatening infection among immunosuppressed patients and is thought to be primarily airborne and can be transmitted from fresh cut flower or potted plants. In this regard the Center of Disease Control (CDC) in the United States of America set guidelines for preventing opportunistic infection in transplant wards and those medical floor that admit patients with severely depressed immune system. These guidelines include evidence based recommendations regarding ventilation, plants and all other health related issues to reduce the number and severity of infections in those immunocompromised patients. According to these guidelines, “Experts strongly recommend that plants and dried or fresh flowers not be allowed in hospital rooms of transplant patient or those who are candidate for this procedure. This is because Aspergillus specious have been isolated from soil of potted plants, the surface of dried flower arrangements, and fresh flowers” (Reference to CDC guidelines; Emerging Infectious Disease, by Dykewicz A, Hospital infection control in hematopoietic stem cell transplant recipients, Vol 7, No 2, March-April 2001).

Bringing fresh cut flowers, potted plants or flower arrangement at bedside of an ill person has always been a pleasant tradition and it is not surprising that floral business in or near hospitals is in demand. Bringing flowers and potted plants by visitors for an ill person is not only a symbol of care and concern for the loved one, it also helps the patient to cope better with physical ailment by release of emotional stress and decrease in psychological tensions resulted from closed hospital environment. By creating more natural looking environment for patient who has to spend a lot of his/her time in this closed surroundings, one might be able to decrease the anxiety, fear, depression and other emotional ailment that are associated with physical illness.

Unfortunately, the limitation that mentioned above result in deprivation of many chronically ill patients to enjoy this very privilege and thus, they are not able to keep and enjoy flowers and potted plants in their environments. This limitation applies to both their temporary environment such as hospital and their permanent residence environment such as home or nursing home.

The object of this invention is to create a completely sealed chamber that would separate potted plants, cut flowers or flower arrangements from the surrounding environment and make it possible for immunosuppressed patients or those who suffer sever allergic disorders to enjoy the loveliness of these natural beauties in their living environment. Using an electrical air pump, plurality of tubing, air filter assembly that includes set of air filter pads and a check valve, the outflow air from the chamber is cleared out of any potential harmful airborne particles including microbes, allergens or fumes that might be harmful to patients and establishing adequate ventilation for animal respiration inside the chamber. This closed chamber is made totally or in part from transparent material including glass, acrylic or other artifact that makes it possible to see the inside of the chamber. Mean time, using mirror, and other decorative artifact could make this display more attractive for hospital environment and/ or patients' house.

As is now apparent, there are many different types of illuminated containers and the like for containing, displaying and stimulating plant growth. Neither of these devices has been made for this specific reason that mentioned above. None the less, prior art in this field are addressed below. These prior arts are mainly patents that deal with providing a closed environment for displaying reasons or improving and stimulating plant growth. These patents include:

1. “Potted plant display stand” U.S. Pat. No. 4,597,550 by Rice Sr. Q in 1986 which proposed a display stand for displaying potted plants at varying angle.

2. “Flower caddy” U.S. Pat. No. 3,973,356 which proposed by Schacht LL in 1993 which could be used for the display and delivery of cut flowers and house plants.

3. “House plant hospital” U.S. Pat. No. 5,241,781 by Malczyk TR, in August 1991 which is a closed illuminated container with fluid and nutrient spraying capabilities to provide a suitable environment for potted plant growth.

4. “Floral Container and water reservoir” U.S. Pat. No. 4,858,381 was proposed by Walton et al in 1989 who proposed a closed reservoir for cut flower.

5. “Plant growing chamber” U.S. Pat. No. 4,543,744 was another patent proposed by Royster in 1985 for plant growing chamber.

6. “Apparatus for stimulating plant growth under controlled condition” U.S. Pat. No. 4,850,135 proposed by DeMarco in 1989.

7. “Supporting structure for plants” U.S. Pat. No. 4,250,666 was patented by Rakestraw in 1981 which was a device for gardening and decorative purposes.

8. “Hydroponic apparatus” U.S. Pat. No. 4,198,783 proposed by Leroux in 1980 for control of plants nutrient and temperature.

9. “Air filtering apparatus and method for using same” 20020136669 was an interesting patent application filed by Marques in 2002 which proposed a plant container to be used as an air filter for cleaning the surrounding air in a closed environment.

All of these patents, incorporated herein by reference, and others, disclose prior art apparatus for containing and displaying potted plants and flowers.

### BRIEF SUMMARY OF THE INVENTION

The present invention is a further improvement in potted plant containers and displays that make it possible to maintain and display potted plants, cut flowers and flower arrangements in indwelling environment of immunsuppressed patients or those with sever allergic disease without exposing them to dangerous airborne microbes, allergens or fumes that are associated with potted plants and flowers.

To reach this, the present invention comprises a closed glass container in which a potted plant, cut flower or flower arrangement may be removably positioned. The side walls of the container are made of transparent artifact including glass, acrylic or combination of any transparent materials. Side walls could also be made of combination of transparent materials and mirror, wood, metal or other decorative artifacts. This makes it possible to see the enclosed potted plants and cut flowers that are positioned inside of the container through removable lid. The contour of the container can be any potential three-dimensional shape including but not limited to hexagonal prism, octagonal prism, triangular prism, cube, rectangular prism, cylinder, dome, sphere, cone, pyramid, diamond, mixed cone & cylinder, curved cylinder or mixture of these shapes. The lid is made in part by glass to make it possible to illuminate inside of the container through an external light source.

The main object of this container is to isolate the plants environment from its surrounding. Therefore, the container is completely air-tight sealed when the lid is closed and ventilation of the enclosed potted plants or flowers inside the chamber is established only through a ventilating system comprising of an air pump assembly, tubing system, air filter assembly and check valve. This ventilating system permits the exchange of air between inside of the chamber and out side of chamber. This ventilating system permit the chamber outflow air to pass through plurality of special air filter pads inside of air filter assembly, which trap any possible airborne particles including fingal spores, microbes, allergens, chemical fumes and other small particles.

### BRIEF DESCRIPTION OF THE SEVERAL VIEWS OF THE DRAWING

Drawing sheet 1, FIG. 1 is a three dimensional view of housing of “Sanitizing Container and Display”. This figure shows a hexagonal prism format of this hosing. This is one of the potential formats of “Sanitizing Container and Display”.

Drawing sheet 2, FIG. 2 is another three dimensional view of hexagonal prism format of housing of “Sanitizing Container and Display”.

Drawing sheet 3, FIG. 3 is a three dimensional view of another format of housing of “Sanitizing Container and Display”. This figure shows a cubical format of this housing.

Drawing sheet 4, FIG. 4 is a three dimensional view of another format of housing of “Sanitizing Container and Display”. This figure shows a rectangular prism format of this housing.

Drawing sheet 5, FIG. 5 is a three dimensional view of another format of housing of “Sanitizing Container and Display”. This figure shows a cylindrical format of this housing.

Drawing sheet 6, FIG. 6 is a three dimensional view of another format of housing of “Sanitizing Container and Display”. This figure shows a dome format of this housing.

Drawing sheet 7, FIG. 7 is a three dimensional view of another format of housing of “Sanitizing Container and Display”. This figure shows a triangular prism format of this housing.

Drawing sheet 8, FIG. 8 is a three dimensional view of another format of housing of “Sanitizing Container and Display”. This figure shows a spherical format of this housing.

Drawing sheet 9, FIG. 9 is a three dimensional view of another format of housing of “Sanitizing Container and Display”. This figure shows a pyramidal format of this housing.

Drawing sheet 10, FIG. 10 is a three dimensional view of another format of housing of “Sanitizing Container and Display”. This figure shows a mixed cylindrical and conical format of this housing.

Drawing sheet 11, FIG. 11 is a three dimensional view of another format of housing of “Sanitizing Container and Display”. This figure shows a conical format of this housing.

Drawing sheet 12, FIG. 12 is a three dimensional view of another format of housing of “Sanitizing Container and Display”. This figure shows a curved cylindrical format of this housing.

Drawing sheet 13, FIG. 13 is an isometric three dimensional view of air pump that ventilate the housing of “Sanitizing Container and Display”.

Drawing sheet 14, FIG. 14 is a another isometric view of air pump, tubing and air filter assembly that ventilate the housing of “Sanitizing Container and Display”.

Drawing sheet 15, FIGS. 15A-15F show multiple views of the air pump, tubing and air filter assembly that ventilate the housing of “Sanitizing Container and Display”.

FIG. 15A is a bottom view of the air pump, tubing and air filter assembly.

FIG. 15B is a right side view of the air pump, tubing and air filter assembly.

FIG. 15C is a top view of the air pump, tubing and air filter assembly.

FIG. 15D is an isometric view of the air pump, tubing and air filter assembly.

FIG. 15E is a front view of the air pump, tubing and air filter assembly.

FIG. 15F is a back view of the air pump, tubing and air filter assembly.

Drawing sheet 16, FIG. 16 is a three dimensional view of air filter assembly including multiple air filters that are used to ventilate the housing of “Sanitizing Container and Display”.

Drawing sheet 17, FIGS. 17A-17D show isometric and sectional views of air filter assembly including air filters that is used to ventilate the housing of “Sanitizing Container and Display”.

FIG. 17A is an isometric view of the air filter assembly.

FIG. 17B is a longitudinal sectional plan of the air filter assembly.

Drawing sheet 18, FIG. 18 is a three dimensional view of air check valve assembly that is used to permit one way passage of air into the “Sanitizing Container and Display”.

Drawing sheet 19, FIGS. 19A-19D show isometric and sectional views of air check valve assembly that is used to permit one way passage of air into the “Sanitizing Container and Display”.

FIG. 19A is an isometric view of the check valve assembly.

FIG. 19B is a longitudinal sectional plan of the check valve assembly.

Drawing sheet 20, FIG. 20 is a three dimensional view of lighting assembly that is used to illuminate the “Sanitizing Container and Display”.

FIG. 20A is a top view of the lighting assembly.

FIG. 20B is a cross sectional plan of the lighting assembly.

FIG. 20C is bottom view of the lighting assembly.

FIG. 20D is an isometric front view of the lighting assembly.

Drawing sheet 21, FIG. 21 is a three dimensional view of the removable lid of the “Sanitizing Container and Display”. This lid is removable and has been designed to make it possible to access inside the container to place and position potted plants, cut flowers and flower arrangements. Using hinges and latches, this lid can be tightly closed. A piece of glass in the middle portion of the lid let the fluorescent light and its cover assembly that are placed on lid illuminate the “Sanitizing Container and Display”.

Drawing sheet 22, FIG. 22 is a three dimensional view of the top of the “Sanitizing Container and Display”. This view shows the upper frame and the lid assembly. In addition it shows how hinges, latches, fluorescent light and its cover, air pump, air filter and check valve are all secured to the lid of “Sanitizing Container and Display”.

Drawing sheet 23, FIGS. 23A-231 show multiple views of the top of the “Sanitizing Container and Display”. This view shows different aspect of the upper frame and the lid. In addition it shows how different parts of the assembly that are secured to the lid.

FIG. 23A is an isometric view of the upper frame and lid assembly.

FIG. 23B is another isometric view of the upper frame and lid assembly.

FIG. 23C is a side view of the upper frame and lid assembly.

FIG. 23D is another isometric view of the upper frame and lid assembly.

FIG. 23E is another isometric view of the upper frame and lid assembly.

FIG. 23F is a top view of the upper frame and lid assembly.

FIG. 23G is another isometric view of the upper frame and lid assembly.

FIG. 23H is another isometric view of the upper frame and lid assembly.

FIG. 23I is another isometric view of the upper frame and lid assembly.

Drawing sheet 24, FIG. 24 is a three dimensional view of the top of the “Sanitizing Container and Display”. This view shows the upper frame and the lid in open position. In addition, it shows the latches, fluorescent light and its cover assembly, air pump, tubing connections and air filter assembly.

Drawing sheet 25, FIGS. 25A-25I show multiple views of the top of the “Sanitizing Container and Display”. This view shows different aspect of the upper frame and the lid in open position. In addition it shows how different parts of the assembly that are secured to the lid.

FIG. 25A is a side view of the upper frame and lid assembly in open position.

FIG. 25B is an isometric view of the upper frame and lid assembly in open position.

FIG. 25C is another isometric view of the upper frame and lid assembly in open position.

FIG. 25D is a front view of the upper frame and lid assembly in open position.

FIG. 25E is a bottom view of the upper frame and lid assembly in open position.

FIG. 25F is another isometric view of the upper frame and lid assembly in open position.

FIG. 25G is another side view of the upper frame and lid assembly in open position.

FIG. 25H is another isometric view of the upper frame and lid assembly in open position.

FIG. 25I is another isometric view of the upper frame and lid assembly in open position.

### DETAILED DESCRIPTION OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

“Sanitizing Container and Display” is made up of several components:

A—Housing
a. Housing structure: As it is depicted in FIG. 1 (Drawing sheet 1), the housing is composed of a closed glass container 2, which can be placed on a furniture stand 4. The glass container embodiment could be made in any possible three dimensional shape including but not limited to hexagonal prism (FIGS. 1-2), cube (FIG. 3), Rectangular prism (FIG. 4), cylinder (FIG. 5), dome (FIG. 6), triangular prism (FIG. 7), sphere (FIG. 8), pyramid (FIG. 9), cone (FIG. 11), diamond, octagonal prism, mixed conical and cylindrical (FIG. 10), curved cylindrical (FIG. 12) or mixture of these shapes. Depending on its shape the glass container is composed of one (FIGS. 5, 6, 8, 10, 11, 12) or multiple glass walls (FIGS. 1, 2, 3, 4, 7, 9). The housing has a removable lid which permits access to housing interior in order to place or position potted plants, cut flowers, vases, or flower arrangements. Based on shape of the housing the features are different, as detailed below:
   i. Hexagonal prism housing: the hexagonal prism housing is composed of a glass container with hexagonal cross section. It has one frame on the top 1 and one frame on the bottom 3 and can be placed on a furniture stand 4. The glass container embodiment is composed of six glass walls 2, a hexagonal floor 5 and a removable hexagonal lid 9. The walls 2 and floor 5 are glued to each other and together produce an air sealed closed environment when the lid 9 is closed. The removable lid 9 permits access to housing interior 6 in order to place or position potted plants, cut flowers, vases, or flower arrangements.
   ii. Cubical housing: the cubical housing is composed of a glass container with square-shaped cross section, which has one frame on the on top 10 and one frame on the bottom 12 and can be placed on a furniture stand 13. The glass container embodiment is composed of four glass walls 11, a square-shaped floor 14 and a removable square-shaped lid 16. The walls 11 and floor 14 are glued to each other and together produce an air sealed closed environment when the lid 16 is closed. The removable lid 16 permits access to housing interior 6.
   iii. Rectangular prism housing: the rectangular prism housing is composed of a glass container with rectangular cross section, which has one frame on the on top 20 and one frame on the bottom 22 and can be placed on a furniture stand 23. The glass container embodiment is composed of four glass walls 21, a rectangular floor 24 and a removable rectangular lid 25. The walls 21 and floor 24 are glued to each other and together produce an air sealed closed environment when the lid 25 is closed. The removable lid 25 permits access to housing interior 6.
   iv. Cylindrical housing: the cylindrical housing is composed of a glass container with circular cross section, which has one frame on the top 31 and one frame on the bottom 33 and can be placed on a furniture stand 34. The glass container embodiment is composed of a piece of cylindrical glass wall 32, a circular floor 35 and a removable circular lid 30. The cylindrical wall 32 and the circular floor 35 are glued to each other and together produce an air sealed closed environment when the lid 30 is closed. The removable lid 30 permits access to housing interior 6.
   v. Dome-shaped housing: the dome-shaped housing is composed of a closed glass container with circular cross section, which is placed on a circular floor 43 and has only one frame on the bottom 41 and can be placed on a furniture stand 42. The glass container embodiment is composed of a piece of dome-shaped hollow glass 40 which is removable. The dome-shaped glass 40 fits tight on the circular floor 43 and bottom frame 41 and produces an air sealed closed environment. The removable dome-shaped glass 40 permits access to housing interior 6.
   vi. Triangular prism housing: the triangular prism housing is composed of a glass container with triangular cross section, which has one frame on the top 51 and one frame on the bottom 53 and can be placed on a furniture stand 54. The glass container embodiment is composed of three glass walls 52, a triangular floor 55 and a removable triangular lid 50. The walls 52 and the triangular floor 55 are glued to each other and together produce an air sealed closed environment when the lid 50 is closed. The removable lid 50 permits access to housing interior 6.
   vii. Spherical housing: the spherical housing is composed of a closed glass container with circular cross section, which is placed on a circular floor 63 and has only one frame on the bottom 61 and can be placed on a furniture stand 62. The glass container embodiment is composed of a piece of hollow spherical glass 60 which is removable. The spherical glass 60 fits tight on the circular floor 63 and bottom frame 61 produces an air sealed closed environment. The removable spherical glass 60 permits access to housing interior 6.
   viii. Pyramidal housing: the pyramidal housing is composed of a closed glass container with square-shaped cross section, which is placed on a square-shaped floor 73 and has one frame on the top 77 and one frame on the bottom 71 and can be placed on a furniture stand 72. The glass container embodiment is composed of four glass walls 70, glued together to form a pyramid, which is removable. The pyramidal glass embodiment 70 fits tight on square-shaped floor 73 and bottom frame 71 produces an air sealed closed environment. The removable pyramidal glass 70 permits access to housing interior 6.
   ix. Mixed conical and cylindrical housing: the mixed conical and cylindrical housing is composed of a glass container with circular cross section, which has one frame on the top 81 and one frame on the bottom 83 and can be placed on a furniture stand 84. The glass container embodiment is composed of a piece of mixed conical and cylindrical glass wall 82 and a circular floor 85, which are glued to each other and together produce an air sealed closed environment when the lid 80 is closed. The removable lid 80 permits access to housing interior 6.
   x. Conical housing: the conical housing is composed of a closed glass container with circular cross section, which is placed on a circular floor 93 and has one frame on the top 97 and one frame on the bottom 91 and can be placed on a furniture stand 92. The glass container embodiment is composed of a piece of hollow conical glass 90 which is removable. The conical glass 90 fits tight on the circular floor 93 and bottom frame 91 and produces an air sealed closed environment. The removable conical glass 90 permits access to housing interior 6.
   xi. Curved cylindrical housing: the curved cylindrical housing is composed of a glass container with circular cross section, which has one frame on the top 1010 and one frame on the bottom 103 and can be placed on a furniture stand 104. The glass container embodiment is composed of a piece of curved cylindrical glass wall 102, a circular floor 105 and a removable circular lid 106. The curved cylindrical wall 102 and the circular floor 105 are glued to each other and together produce an air sealed closed environment when the lid 106 is closed. The removable lid 106 permits access to housing interior 6.
b. Housing floor: Housing floor is a surface in the bottom sides of the housing where the side walls are positioned. Depending on type of housing, this surface has different shape and could be either glued to the housing walls or be removably mounted to the walls. The detail of each housing floor is mentioned below:
   i. Hexagonal prism housing: the floor 5 in the hexagonal prism housing (FIGS. 1-2) is composed of a hexagonal surface, which could be made of glass, wood, plastic, metal or other material and is permanently glued to said bottom frame 3 and the bottom part of said six glass housing walls 2. Inside of the housing 6, the potted plants, cut flowers, vases, or flower arrangement could be removably placed on top of housing floor 5.
   ii. Cubical housing: the floor 14 in the cubical housing (FIG. 3) is composed of a square shaped surface, which could be made of glass, wood, plastic, metal or other material and is permanently glued to said bottom frame 12 and the bottom part of said four glass housing walls 11. Inside of the housing 6, the potted plants, cut flowers, vases, or flower arrangement could be removably placed on top of housing floor 14.
   iii. Rectangular prism housing: the floor 24 in the rectangular prism housing (FIG. 4) is composed of a rectangular surface, which could be made of glass, wood, plastic, metal or other material and is permanently glued to said bottom frame 22 and the bottom part of said four glass housing walls 21. Inside of the housing 6, the potted plants, cut flowers, vases, or flower arrangement could be removably placed on top of housing floor 24.
   iv. Cylindrical housing: the floor 35 in the cylindrical housing (FIG. 5) is composed of a circular surface, which could be made of glass, wood, plastic, metal or other material and is permanently glued to the bottom part of said bottom frame 33 and said glass cylindrical housing wall 32. Inside of the housing 6, the potted plants, cut flowers, vases, or flower arrangement could be removably placed on top of housing floor 35.
   v. Dome-shaped housing: the floor 43 in the dome-shaped housing (FIG. 6) is composed of a circular surface that is permanently glued to said bottom frame 41 and has a groove 44 with a circular washer 45 which accommodate the dome-shaped glass housing 40. The bottom part of the dome-shaped glass housing 40 fits tight on the circular floor groove 44 and bottom frame 41 and produces an air sealed closed environment. The removable dome-shaped glass housing 40 permits access to housing interior 6. In this type of housing the floor 43 is made of two pieces. The rim is made of wood, plastic, metal or other material and is in periphery. The central part 46 is made of a circular glass, which is permanently glued to the rim piece and is a mean through which, the housing interior will be illuminated through an external lighting source 141 that are positioned beneath the housing floor inside the bottom frame 41. Beside of lighting source 8, air pump assembly 7, tubing system 114, 116, air filter assembly 115 and check valve assembly 136 are also placed beneath the housing floor, and are covered by said bottom frame 41. Inside of the housing 6, the potted plants, cut flowers, vases, or flower arrangement could be removably placed on top of housing floor 43.
   vi. Triangular prism housing: the floor 55 in the triangular prism housing (FIG. 7) is composed of a triangular surface, which could be made of glass, wood, plastic, metal or other material and is permanently glued to said bottom frame 53 and the bottom part of said three glass housing walls 52. Inside of the housing 6, the potted plants, cut flowers, vases, or flower arrangement could be removably placed on top of housing floor 35.
   vii. Spherical housing: the floor 63 in the spherical housing (FIG. 8) is composed of a circular surface that is permanently glued to said bottom frame 61 and has a groove 64 with a circular washer 65 which accommodate the spherical glass housing 60. The spherical glass housing 60 fits tight on the circular floor groove 64 and bottom frame 61 and produces an air sealed closed environment. The removable spherical glass housing 60 permits access to housing interior 6. In this type of housing the floor 63 is made of two pieces. The rim is made of wood, plastic, metal or other material and is in periphery. The central part 66 is made of a circular glass, which is permanently glued to the rim piece and is a mean through which, the housing interior will be illuminated through an external lighting source 141 that are positioned beneath the housing floor inside the bottom frame 61. Beside of lighting source 8, air pump assembly 7, tubing system 114, 116, air filter assembly 115 and check valve assembly 136 are also placed beneath the housing floor and are covered by said bottom frame 61. Inside of the housing 6, the potted plants, cut flowers, vases, or flower arrangement could be removably placed on top of housing floor 63.
   viii. Pyramidal housing: the floor 73 in the pyramidal housing (FIG. 9) is composed of a square-shaped surface that is permanently glued to said bottom frame 71 and has a groove 74 with a square-shaped washer 75 which accommodate the pyramidal glass housing 70. The pyramidal glass housing 70 fits tight on the square-shaped floor groove 74 and bottom frame 71 and produces an air sealed closed environment. The removable pyramidal glass housing 70 permits access to housing interior 6. In this type of housing the floor 73 is made of two pieces. The rim is made of wood, plastic, metal or other material and is in periphery. The central part 76 is made of a circular glass, which is permanently glued to the rim piece and is a mean through which, the housing interior will be illuminated through an external lighting source 141 that are positioned beneath the housing floor inside the bottom frame 71. Beside of lighting source 8, air pump assembly 7, tubing system 114, 116, air filter assembly 115 and check valve assembly 136 are also placed beneath the housing floor and are covered by said bottom frame 71. Inside of the housing 6, the potted plants, cut flowers, vases, or flower arrangement could be removably placed on top of housing floor 73.
   ix. Mixed conical and cylindrical housing: the floor 85 in the mixed conical and cylindrical housing (FIG. 10) is composed of a circular surface, which could be made of glass, wood, plastic, metal or other material and is permanently glued to said bottom frame 83 and the bottom part of said mixed conical and cylindrical glass housing wall 82. Inside of the housing 6, the potted plants, cut flowers, vases, or flower arrangement could be removably placed on top of housing floor 85.
   x. Conical housing: the floor 93 in the conical housing (FIG. 11) is composed of a circular surface that is permanently glued to said bottom frame 91 and has a groove 94 with a circular washer 95 which accommodate the conical glass housing 90. The conical glass housing 90 fits tight on the circular floor 93 and bottom frame 91 and produces an air sealed closed environment. The removable conical glass housing 90 permits access to housing interior 6. In this type of housing the floor 93 is made of two pieces. The rim is made of wood, plastic, metal or other material and is in periphery. The central part 96 is made of a circular glass, which is permanently glued to the rim piece and is a mean through which, the housing interior will be illuminated through an external lighting source 141 that are positioned beneath the housing floor inside the bottom frame 91. Beside of lighting source 8, air pump assembly 7, tubing system 114, 116, air filter assembly 115 and check valve assembly 136 are also placed beneath the housing floor and are covered by said bottom frame 91. Inside of the housing 6, the potted plants, cut flowers, vases, or flower arrangement could be removably placed on top of housing floor 93.
   xi. Curved cylindrical housing: the floor 105 in the curved cylindrical housing (FIG. 12) is composed of a circular surface, which could be made of glass, wood, plastic, metal or other material and is permanently glued to said bottom frame 103 and the bottom part of said curved cylindrical glass housing walls 102. Inside of the housing 6, the potted plants, cut flowers, vases, or flower arrangement could be removably placed on top of housing floor 105.
c. Upper frame: is a frame-like structure that encases the upper part of the housing walls. It is made of wood, plastic, metal or other material and permanently glued to the upper part of the walls. Depending on type of housing, this structure is different in shape. The detail of each housing upper frame is mentioned below:
   i. Hexagonal prism housing: the upper frame 1 in the hexagonal prism housing (FIGS. 1-2) is a hexagonal rim, which is permanently glued to the upper borders of said six glass housing walls 2 and encase the upper borders of the housing. It also accommodates the housing lid 9. Using a pair of hinge joints 150 that connect the said upper frame 1 to the housing lid 9, said lid 9 could move to open (FIGS. 24, 25). Using a pair of latches 151 on said lid 9 that slide in to slits 152 on said frame 1 the said lid 9 could be tightly closed (FIG. 22) to produce an air sealed closed environment inside the housing 6. Upper frame 1 also create a potential space on top of housing lid that embodiments including, lighting source 8, air pump assembly 7, tubing system 114, 116, air filter assembly 115 and check valve assembly 136 could be placed.
   ii. Cubical housing: the upper frame 10 in the cubical housing (FIG. 3) is a square-shaped rim, which is permanently glued to the upper borders of said four glass housing walls 11 and encase the upper borders of the housing. It also accommodates the housing lid 16. Using a pair of hinge joints 150 that connect the said upper frame 10 to the housing lid 16, said lid 16 could move to open. Using a pair of latches 151 on said lid 16 that slide in to slits 152 on said frame 10 the said lid 16 could be tightly closed to produce an air sealed closed environment inside the housing 6. Upper frame 10 also create a potential space on top of housing lid that embodiments including, lighting source 8, air pump assembly 7, tubing system 114, 116, air filter assembly 115 and check valve assembly 136 could be placed.
   iii. Rectangular prism housing: the upper frame 20 in the rectangular prism housing (FIG. 4) is a rectangular rim, which is permanently glued to the upper borders of said four glass housing walls 11 and encases the upper borders of the housing. It also accommodates the housing lid 25. Using a pair of hinge joints 150 that connect the said upper frame 20 to the housing lid 25, said lid 25 could move to open. Using a pair of latches 151 on said lid 25 that slide in to slits 152 on said frame 20 the said lid 25 could be tightly closed to produce an air sealed closed environment inside the housing 6. Upper frame 20 also create a potential space on top of housing lid that embodiments including, lighting source 8, air pump assembly 7, tubing system 114, 116, air filter assembly 115 and check valve assembly 136 could be placed.
   iv. Cylindrical housing: the upper frame 31 in the cylindrical housing (FIG. 5) is a circular rim, which is permanently glued to the upper borders of said cylindrical glass housing wall 32 and encase the upper borders of the housing. It also accommodates the housing lid 30. Using a hinge joint 150 that connect the said upper frame 31 to the housing lid 30, said lid 30 could move to open. Using a latch 151 on said lid 30 that slide in to a slit 152 on said frame 31 the said lid 30 could be tightly closed to produce an air sealed closed environment inside the housing 6. Upper frame 31 also create a potential space on top of housing lid that embodiments including, lighting source 8, air pump assembly 7, tubing system 114, 116, air filter assembly 115 and check valve assembly 136 could be placed.
   v. Dome-shaped housing: does not have upper frame.
   vi. Triangular prism housing: the upper frame 51 in the triangular prism housing (FIG. 7) is a triangular rim, which is permanently glued to the upper borders of said four glass housing walls 52 and encases the upper borders of the housing. It also accommodates the housing lid 50. Using a pair of hinge joints 150 that connect the said upper frame 51 to the housing lid 50, said lid 50 could move to open. Using a pair of latches 151 on said lid 50 that slide in to slits 152 on said frame 51 the said lid 50 could be tightly closed to produce an air sealed closed environment inside the housing 6. Upper frame 51 also create a potential space on top of housing lid that embodiments including, lighting source 8, air pump assembly 7, tubing system 114, 116, air filter assembly 115 and check valve assembly 136 could be placed.
   vii. Spherical housing: does not have upper frame.
   viii. Pyramidal housing: the pyramidal housing has a small upper frame 77 which is a pyramidal shape and permanently glued to the upper borders of said four glass housing walls 70. It is decorative structure and does not have any functional importance.
   ix. Mixed conical and cylindrical housing: the upper frame 81 in the mixed conical and cylindrical housing (FIG. 10) is a circular rim, which is permanently glued to the upper borders of said mixed conical and cylindrical glass housing wall 82 and encase the upper borders of the housing. It also accommodates the housing lid 80. Using a hinge joint 150 that connect the said upper frame 81 to the housing lid 80, said lid 80 could move to open. Using a latch 151 on said lid 80 that slide in to a slit 152 on said frame 81 the said lid 80 could be tightly closed to produce an air sealed closed environment inside the housing 6.

Upper frame 81 also create a potential space on top of housing lid that embodiments including, lighting source 8, air pump assembly 7, tubing system 114, 116, air filter assembly 115 and check valve assembly 136 could be placed.
x. Conical housing: the conical housing has a small upper frame 97 which is a conical shape and permanently glued to the upper borders of said conical glass housing wall 90. It is decorative structure and does not have any functional importance.
xi. Curved cylindrical housing: the upper frame 101 in the curved cylindrical housing (FIG. 12) is a circular rim, which is permanently glued to the upper borders of said curved cylindrical glass housing wall 102 and encase the upper borders of the housing. It also accommodates the housing lid 100.

Using a hinge joint 150 that connect the said upper frame 101 to the housing lid 100, said lid 100 could move to open. Using a latch 151 on said lid 100 that slide in to a slit 152 on said frame 101 the said lid 100 could be tightly closed to produce an air sealed closed environment inside the housing 6. Upper frame 101 also create a potential space on top of housing lid that embodiments including, lighting source 8, air pump assembly 7, tubing system 114, 116, air filter assembly 115 and check valve assembly 136 could be placed.
d. Bottom frame: is a frame-like structure that encases the housing floor and accommodates either permanently or removably the lower part of the housing walls. It is made of wood, plastic, metal or other material and depending on type of housing, this structure is different in shape. Beneath the housing floor there is a potential space that is surrounded by bottom frame which can accommodate lighting source 8, air pump assembly 7, tubing system 114, 116, air filter assembly 115 and check valve assembly 136 in those housings that do not have removable lid. The detail of each housing bottom frame is mentioned below:
   i. Hexagonal prism housing: the bottom frame 3 in the hexagonal prism housing (FIG. 1-2) is a hexagonal rim, which is permanently glued to the housing floor 5 and the lower borders of said six glass housing walls 2 and encase the lower borders of the housing. This frame 3 bears the weight of the housing and produces a space beneath the housing floor 5 for potential embodiments.
   ii. Cubical housing: the bottom frame 12 in the cubical housing (FIG. 3) is a square-shaped rim, which is permanently glued to the housing floor 14 and the lower borders of said four glass housing walls 11 and encase the lower borders of the housing. This frame 12 bears the weight of the housing and produces a space beneath the housing floor 14 for potential embodiments.
   iii. Rectangular prism housing: the bottom frame 22 in the rectangular prism housing (FIG. 4) is a rectangular rim, which is permanently glued to the housing floor 24 and the lower borders of said four glass housing walls 21 and encases the lower borders of the housing. This frame 22 bears the weight of the housing and produces a space beneath the housing floor 24 for potential embodiments.
   iv. Cylindrical housing: the bottom frame 33 in the cylindrical housing (FIG. 5) is a circular rim, which is permanently glued to the housing floor 35 and the lower borders of said cylindrical glass housing wall 32 and encase the lower borders of the housing. This frame 33 bears the weight of the housing and produces a space beneath the housing floor 35 for potential embodiments.
   v. Dome-shaped housing: the bottom frame 41 in the dome-shaped housing (FIG. 6) is a circular rim, which is permanently glued to the housing floor 43. The bottom part of the dome-shaped glass housing 40 fits tightly on the circular floor groove 44 and bottom frame 41 and produces an air sealed closed environment. This frame 33 bears the weight of the housing and produces a space beneath the housing floor 43 for several embodiments including, lighting source 8, air pump assembly 7, tubing system 114, 116, air filter assembly 115 and check valve assembly 136.
   vi. Triangular prism housing: the bottom frame 53 in the triangular prism housing (FIG. 7) is a triangular rim, which is permanently glued to the housing floor 55 and the lower borders of said four glass housing walls 52 and encases the lower borders of the housing. This frame 53 bears the weight of the housing and produces a space beneath the housing floor 55 for potential embodiments.
   vii. Spherical housing: the bottom frame 61 in the spherical housing (FIG. 8) is a circular rim, which is permanently glued to the housing floor 63. The bottom part of the spherical glass housing 60 fits tightly on the circular floor groove 64 and bottom frame 61 and produces an air sealed closed environment. This frame 61 bears the weight of the housing and produces a space beneath the housing floor 63 for several embodiments including, lighting source 8, air pump assembly 7, tubing system 114, 116, air filter assembly 115 and check valve assembly 136.
   viii. Pyramidal housing: the bottom frame 71 in the pyramidal housing (FIG. 9) is a square-shaped rim, which is permanently glued to the housing floor 73. The bottom part of the pyramidal glass housing 70 fits tightly on the square-shaped floor groove 74 and bottom frame 71 and produces an air sealed closed environment. This frame 71 bears the weight of the housing and produces a space beneath the housing floor 73 for several embodiments including, lighting source 8, air pump assembly 7, tubing system 114, 116, air filter assembly 115 and check valve assembly 136.
   ix. Mixed conical and cylindrical housing: the bottom frame 83 in the mixed conical and cylindrical housing (FIG. 11) is a circular rim, which is permanently glued to the housing floor 85 and the lower borders of said cylindrical glass housing wall 82 and encase the lower borders of the housing. This frame 83 bears the weight of the housing and produces a space beneath the housing floor 85 for potential embodiments.
   x. Conical housing: the bottom frame 91 in the conical housing (FIG. 9) is a circular rim, which is permanently glued to the housing floor 93. The bottom part of the conical glass housing 70 fits tightly on the circular floor groove 94 and bottom frame 91 and produces an air sealed closed environment. This frame 91 bears the weight of the housing and produces a space beneath the housing floor 93 for several embodiments including, lighting source 8, air pump assembly 7, tubing system 114, 116, air filter assembly 115 and check valve assembly 136.
   xi. Curved cylindrical housing: the bottom frame 103 in the curved cylindrical housing (FIG. 12) is a circular rim, which is permanently glued to the housing floor 105 and the lower borders of said cylindrical glass housing wall 102 and encase the lower borders of the housing. This frame 103 bears the weight of the housing and produces a space beneath the housing floor 105 for potential embodiments.
e. Housing lid: Housing lid is a movable part of the housing that is positioned on top of the housing and permits access to the housing interior 6 in order to place or position potted plants, cut flowers, vases, or flower arrangements. Depending on the type of housing, this structure is either absent or different in shape as is detailed below:
   i. Hexagonal prism housing: the lid 9 in the hexagonal prism housing (FIGS. 1-2) is composed of a hexagonal surface.

Housing lid 16 is a movable part of the housing and is positioned on top of the housing to permit access to the housing interior 6 to place or position potted plants, cut flowers, vases, or flower arrangements. Using a pair of hinge joints 150 that connect the said upper frame 1 to the housing lid 9, said lid 9 could move to open (FIGS. 24, 25). Using a pair of latches 151 on said lid 9 that slide in to slits 152 on said frame 1 the said lid 9 could be tightly closed (FIG. 22) to produce an air sealed closed environment inside the housing 6. The housing lid 9 is made of two pieces. The rim is made of wood, plastic, metal or other material and is in periphery. The central part 152 is made of glass, which is permanently glued to the rim piece and is a mean through which, the housing interior will be illuminated through an external lighting source 8 that are positioned above the housing lid. Beside of lighting source 8, air pump assembly 7, tubing system 114, 116, air filter assembly 115 and check valve assembly 136 are also placed above the housing lid.
ii. Cubical housing: the lid 16 in the cubical housing (FIG. 3) is composed of a square-shaped surface. Housing lid 16 is a movable part of the housing and is positioned on top of the housing to permit access to the housing interior 6 to place or position potted plants, cut flowers, vases, or flower arrangements. Using a pair of hinge joints 150 that connect the said upper frame 10 to the housing lid 16, said lid 16 could move to open (FIGS. 24, 25). Using a pair of latches 151 on said lid 16 that slide in to slits 152 on said frame 10 the said lid 9 could be tightly closed (FIG. 22) to produce an air sealed closed environment inside the housing 6. The housing lid 16 is made of two pieces. The rim is made of wood, plastic, metal or other material and is in periphery. The central part 15 is made of glass, which is permanently glued to the rim piece and is a mean through which, the housing interior will be illuminated through an external lighting source 141 that are positioned above the housing lid. Beside of lighting source 8, air pump assembly 7, tubing system 114, 116, air filter assembly 115 and check valve assembly 136 are also placed above the housing lid.
iii. Rectangular prism housing: the lid 25 in the rectangular prism housing (FIG. 4) is composed of a rectangular surface. Housing lid 25 is a movable part of the housing and is positioned on top of the housing to permit access to the housing interior 6 to place or position potted plants, cut flowers, vases, or flower arrangements. Using a pair of hinge joints 150 that connect the said upper frame 20 to the housing lid 25, said lid 25 could move to open (FIGS. 24, 25). Using a pair of latches 151 on said lid 25 that slide in to slits 152 on said frame 20 the said lid 25 could be tightly closed (FIG. 22) to produce an air sealed closed environment inside the housing 6. The housing lid 25 is made of two pieces. The rim is made of wood, plastic, metal or other material and is in periphery. The central part 26 is made of glass, which is permanently glued to the rim piece and is a mean through which, the housing interior will be illuminated through an external lighting source 8 that are positioned above the housing lid. Beside of lighting source 8, air pump assembly 7, tubing system 114, 116, air filter assembly 115 and check valve assembly 136 are also placed above the housing lid.
iv. Cylindrical housing: the lid 30 in the cylindrical housing (FIG. 5) is composed of a circular surface. Housing lid 30 is a movable part of the housing and is positioned on top of the housing to permit access to the housing interior 6 to place or position potted plants, cut flowers, vases, or flower arrangements. Using a pair of hinge joints 150 that connect the said upper frame 31 to the housing lid 30, said lid 30 could move to open (FIGS. 24, 25). Using a pair of latches 151 on said lid 30 that slide in to slits 152 on said frame 31 the said lid 30 could be tightly closed (FIG. 22) to produce an air sealed closed environment inside the housing 6. The housing lid 30 is made of two pieces. The rim is made of wood, plastic, metal or other material and is in periphery. The central part 36 is made of glass, which is permanently glued to the rim piece and is a mean through which, the housing interior will be illuminated through an external lighting source 141 that are positioned above the housing lid. Beside of lighting source 8, air pump assembly 7, tubing system 114, 116, air filter assembly 115 and check valve assembly 136 are also placed above the housing lid.
v. Dome-shaped housing: does not have housing lid.
vi. Triangular prism housing: the lid 50 in the triangular prism housing (FIG. 7) is composed of a triangular surface. Housing lid 50 is a movable part of the housing and is positioned on top of the housing to permit access to the housing interior 6 to place or position potted plants, cut flowers, vases, or flower arrangements. Using a pair of hinge joints 150 that connect the said upper frame 51 to the housing lid 50, said lid 50 could move to open (FIGS. 24, 25). Using a pair of latches 151 on said lid 50 that slide in to slits 152 on said frame 51 the said lid 50 could be tightly closed (FIG. 22) to produce an air sealed closed environment inside the housing 6. The housing lid 50 is made of two pieces. The rim is made of wood, plastic, metal or other material and is in periphery. The central part 56 is made of glass, which is permanently glued to the rim piece and is a mean through which, the housing interior will be illuminated through an external lighting source 8 that are positioned above the housing lid. Beside of lighting source 8, air pump assembly 7, tubing system 114, 116, air filter assembly 115 and check valve assembly 136 are also placed above the housing lid.
vii. Spherical housing: does not have housing lid.
viii. Pyramidal housing: does not have housing lid.
ix. Mixed conical and cylindrical housing: the lid 80 in the mixed conical and cylindrical housing (FIG. 10) is composed of a circular surface. Housing lid 80is a movable part of the housing and is positioned on top of the housing to permit access to the housing interior 6 to place or position potted plants, cut flowers, vases, or flower arrangements. Using a pair of hinge joints 150 that connect the said upper frame 81 to the housing lid 80, said lid 80 could move to open (FIGS. 24, 25). Using a pair of latches 151 on said lid 80 that slide in to slits 152 on said frame 81 the said lid 80 could be tightly closed (FIG. 22) to produce an air sealed closed environment inside the housing 6. The housing lid 80 is made of two pieces. The rim is made of wood, plastic, metal or other material and is in periphery. The central part 86 is made of glass, which is permanently glued to the rim piece and is a mean through which, the housing interior will be illuminated through an external lighting source 141 that are positioned above the housing lid. Beside of lighting source 8, air pump assembly 7, tubing system 114, 116, air filter assembly 115 and check valve assembly 136 are also placed above the housing lid.
x. Conical housing: does not have housing lid.
xi. Curved cylindrical housing: the lid 100 in the curved cylindrical housing (FIG. 12) is composed of a circular surface. Housing lid 100 is a movable part of the housing and is positioned on top of the housing to permit access to the housing interior 6 to place or position potted plants, cut flowers, vases, or flower arrangements. Using a pair of hinge joints 150 that connect the said upper frame 101 to the housing lid 100, said lid 100 could move to open (FIGS. 24, 25). Using a pair of latches 151 on said lid 100 that slide in to slits 152 on said frame 101 the said lid 100 could be tightly closed (FIG. 22) to produce an air sealed closed environment inside the housing 6. The housing lid 100 is made of two pieces. The rim is made of wood, plastic, metal or other material and is in periphery. The central part 106 is made of glass, which is permanently glued to the rim piece and is a mean through which, the housing interior will be illuminated through an external lighting source 141 that are positioned above the housing lid. Beside of lighting source 8, air pump assembly 7, tubing system 114, 116, air filter assembly 115 and check valve assembly 136 are also placed above the housing lid.
f. Housing stand: Housing stand is a piece of furniture that the housing could be placed on that and is mainly decorative part. Although, this part is an optional portion, it makes the container more suitable display. It could also be used as a potential space for containing accessories.

B—Ventilation System

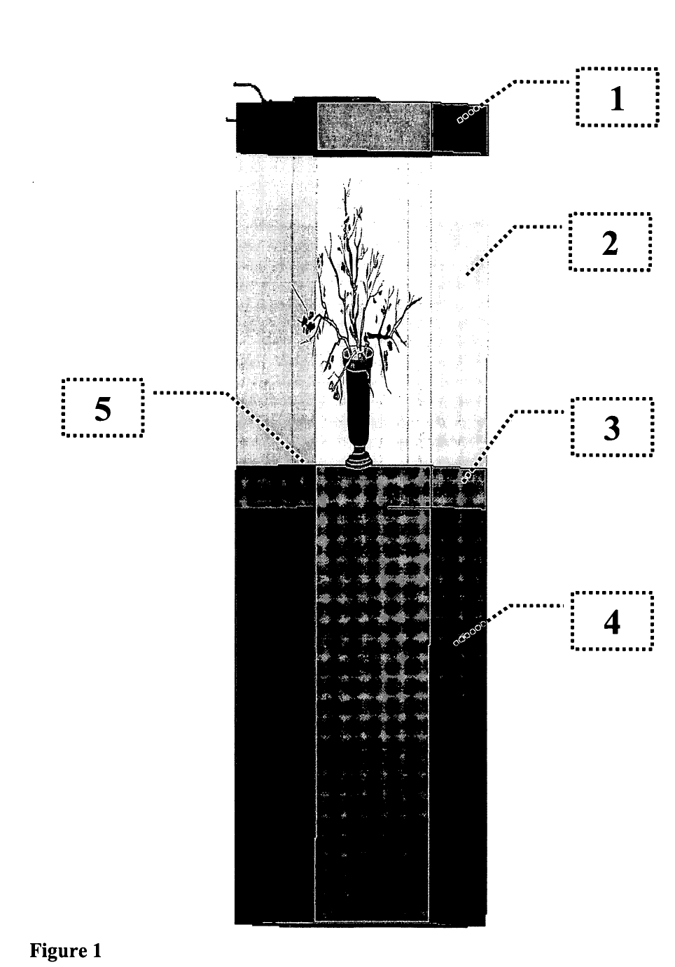

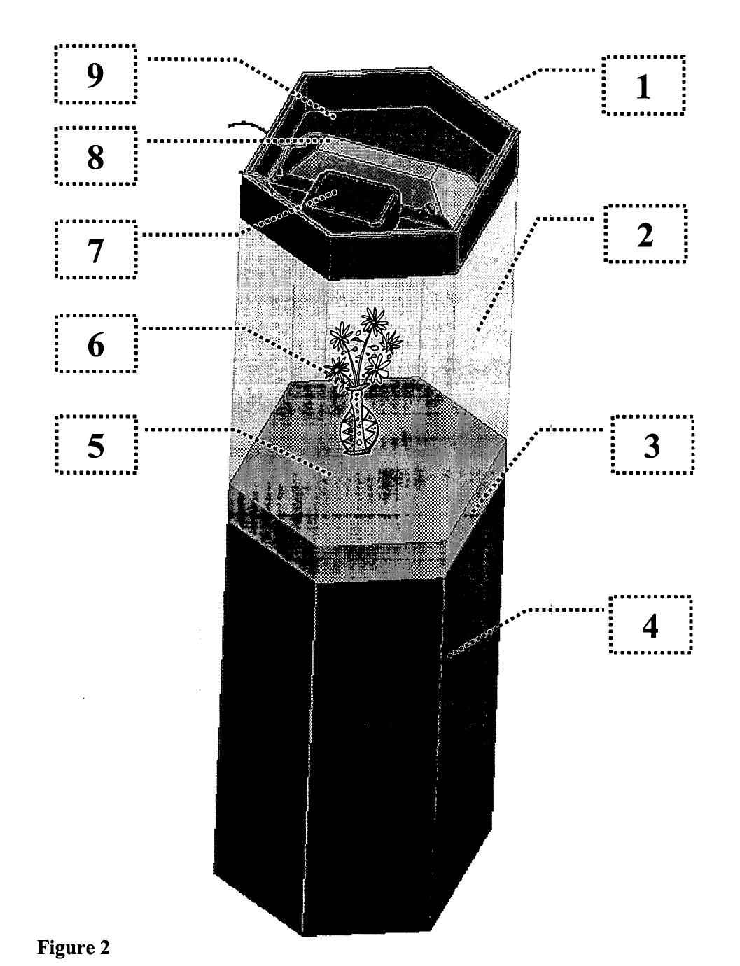

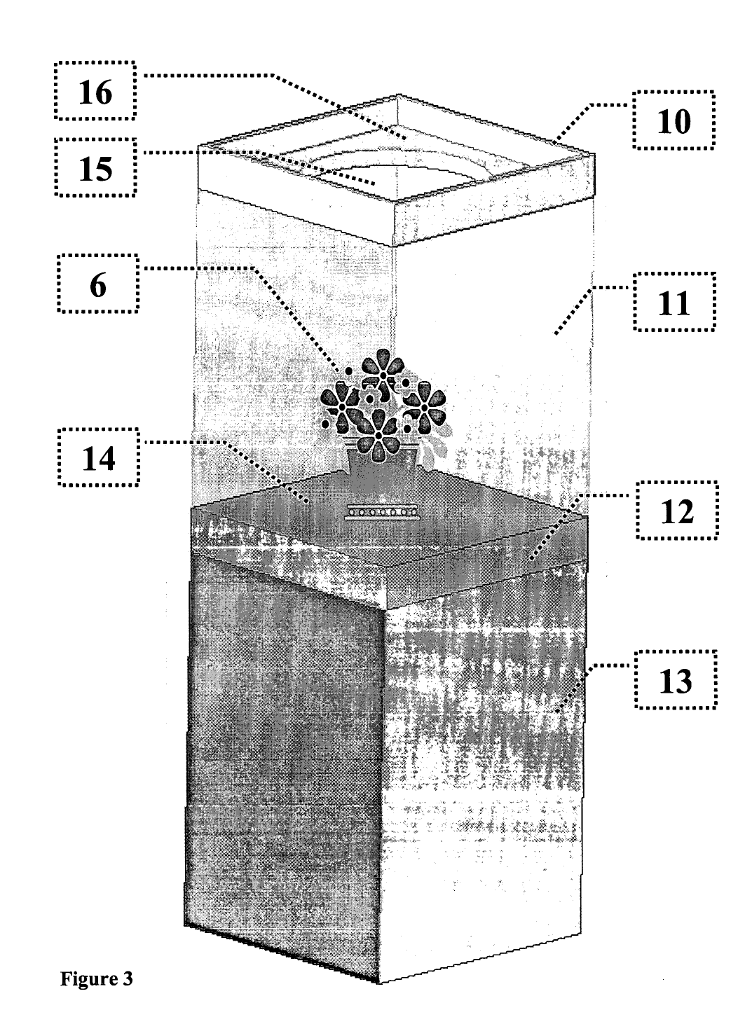

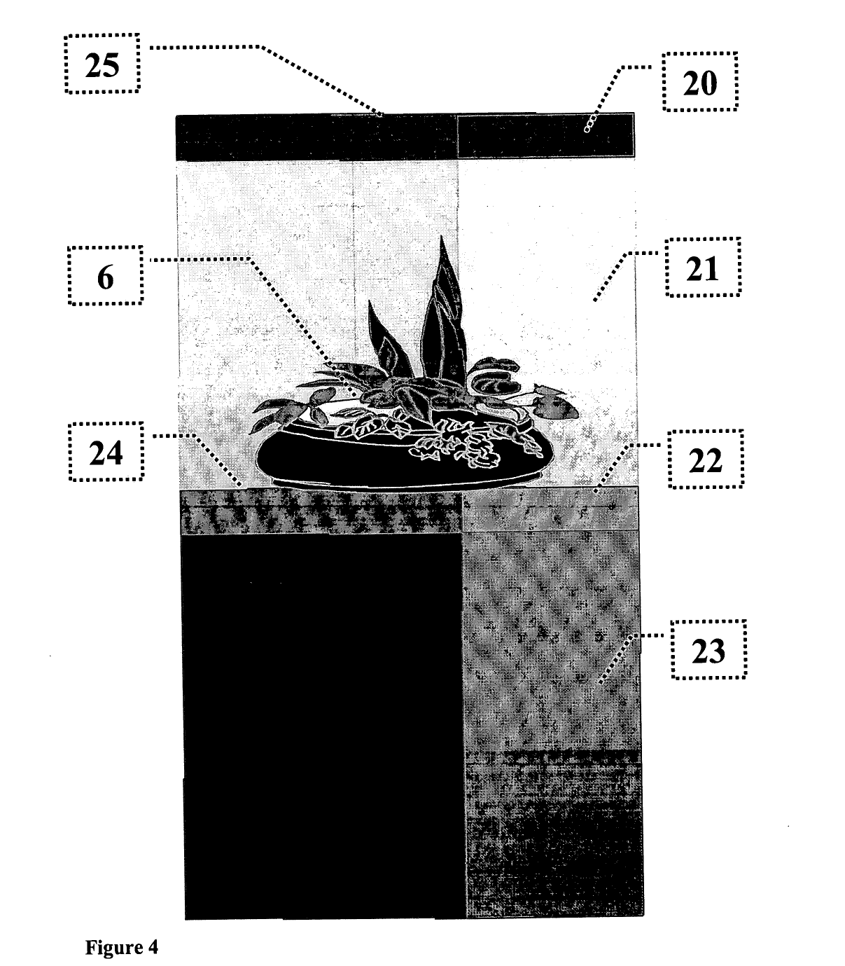

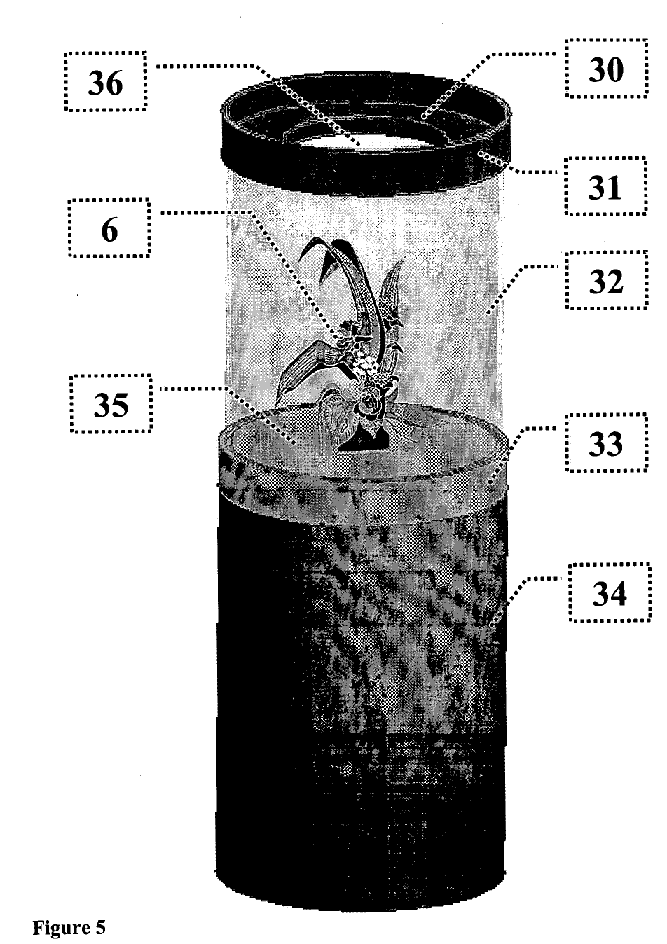

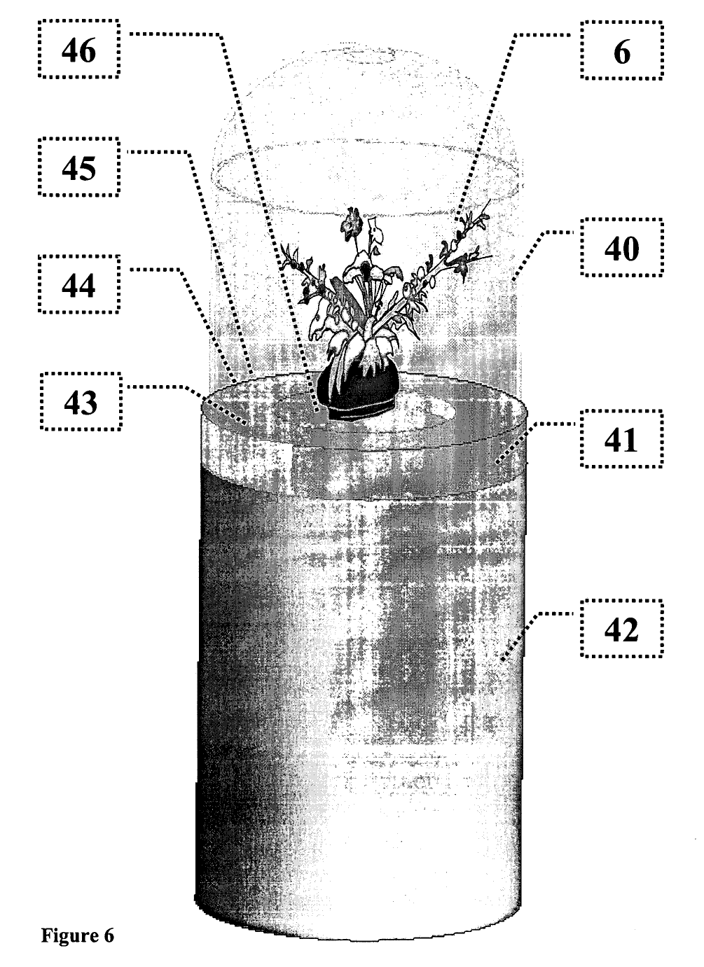

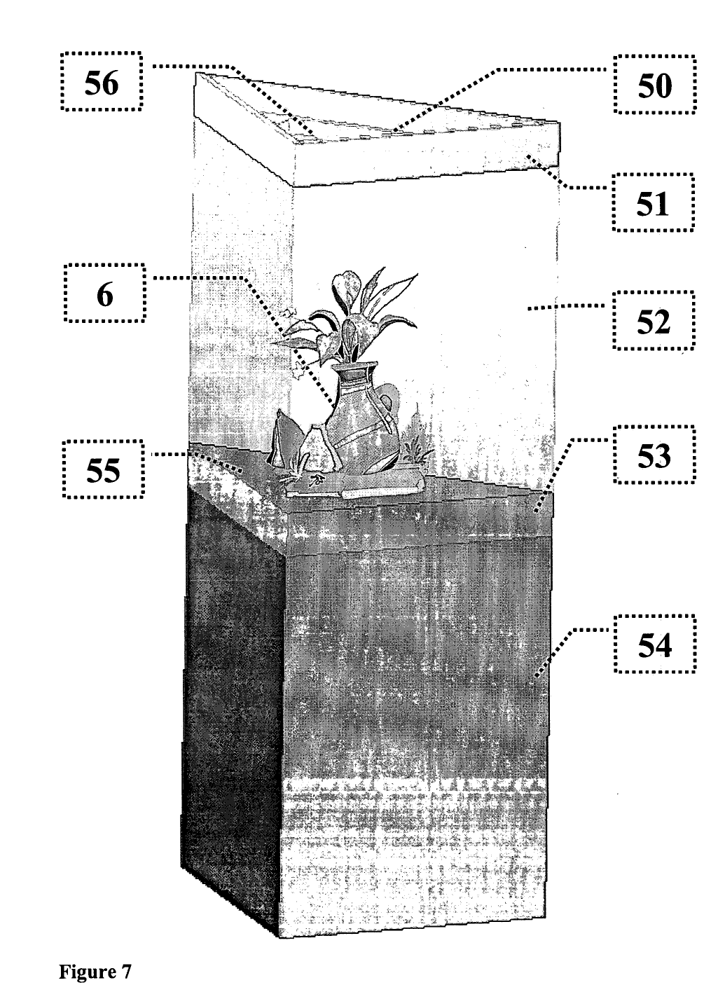

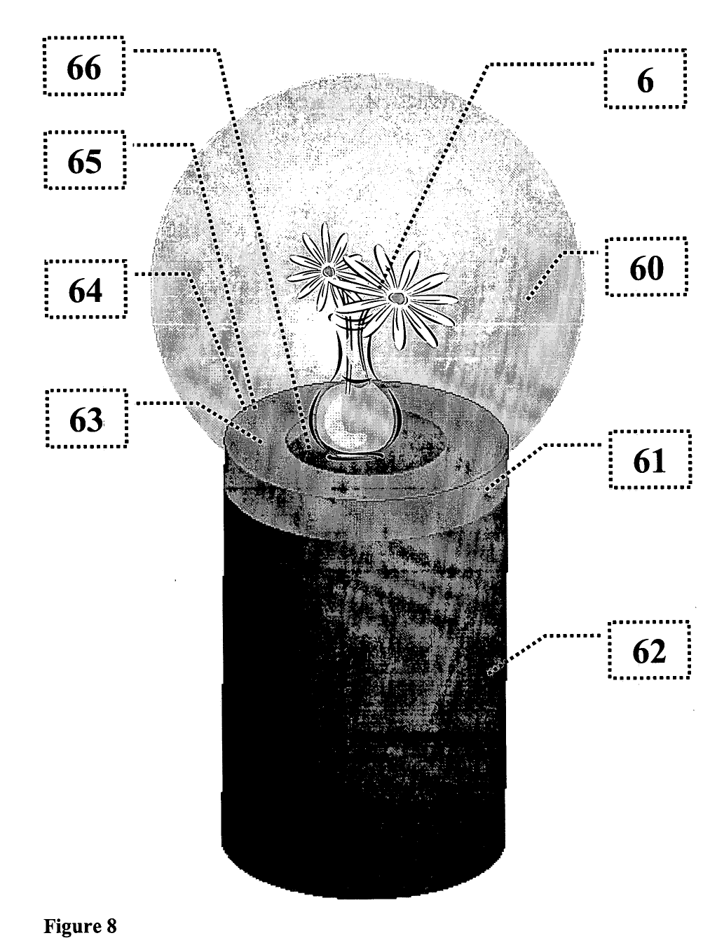

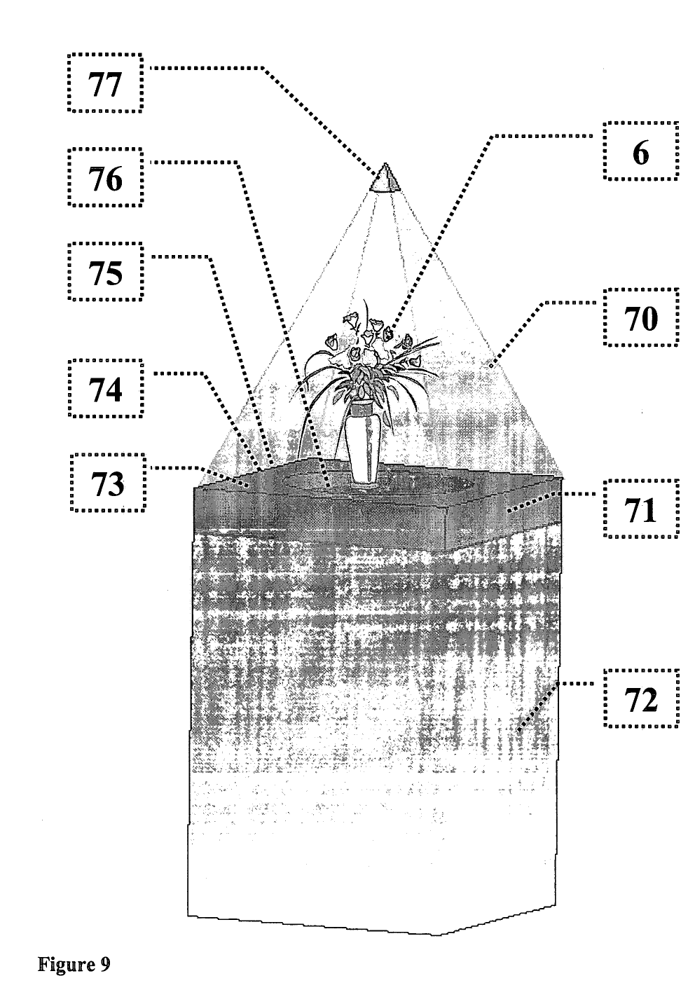

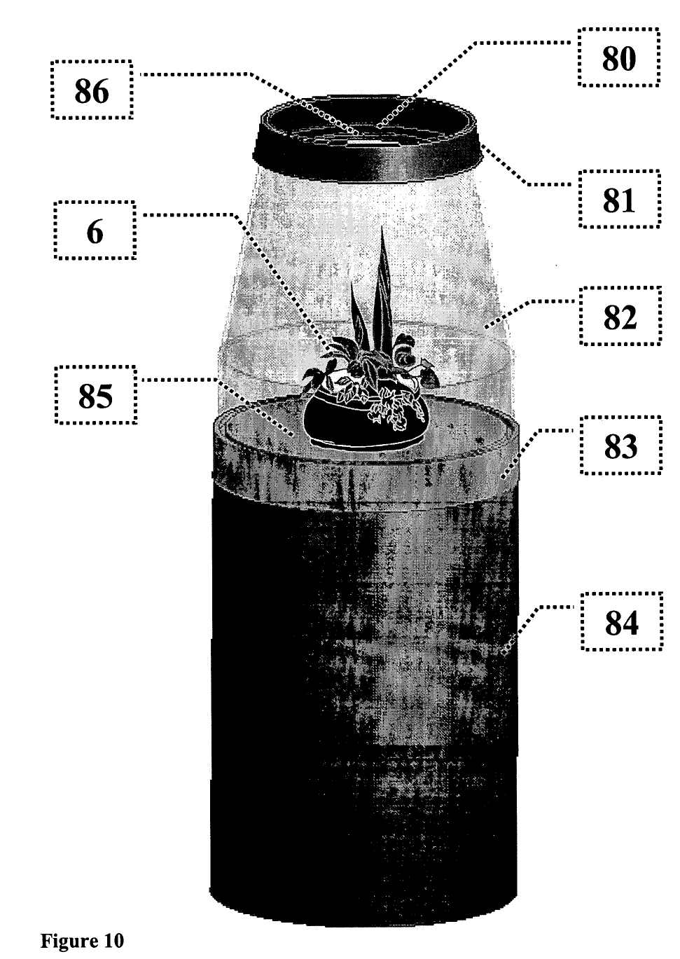

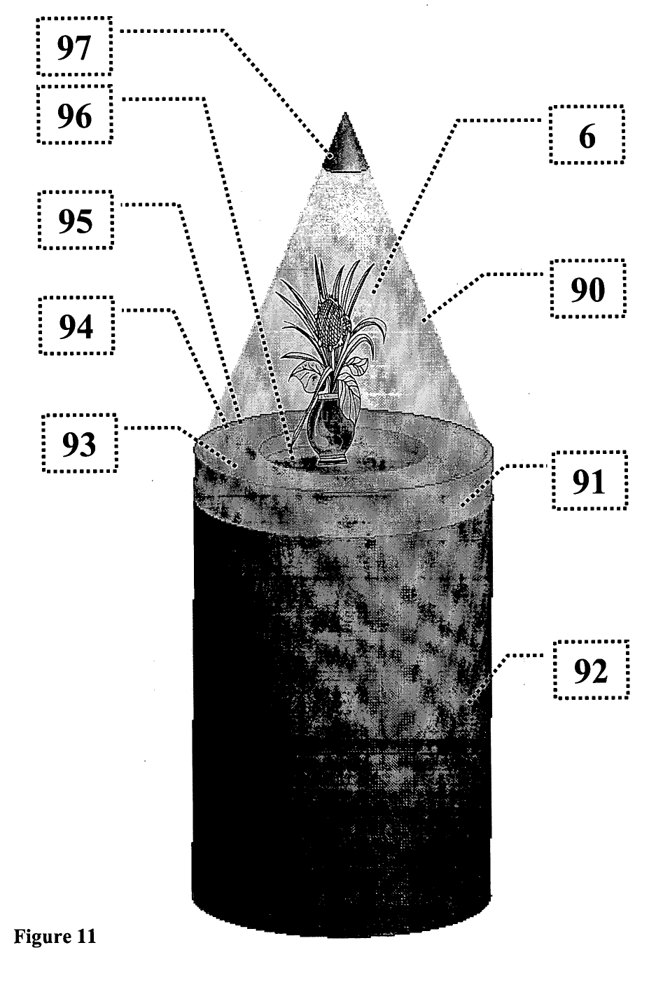

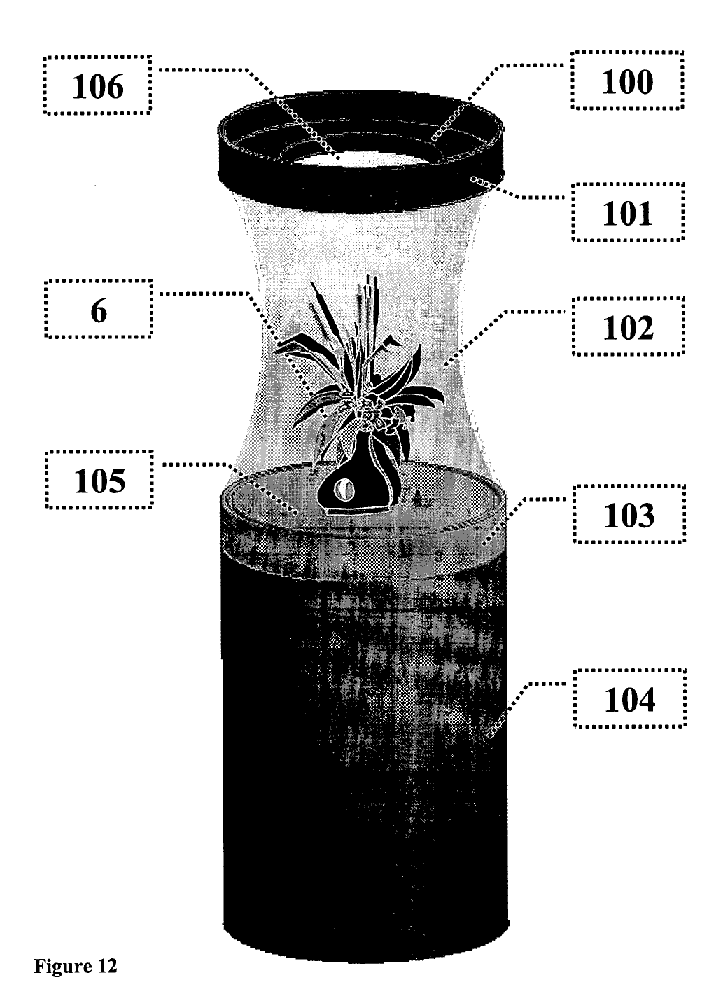

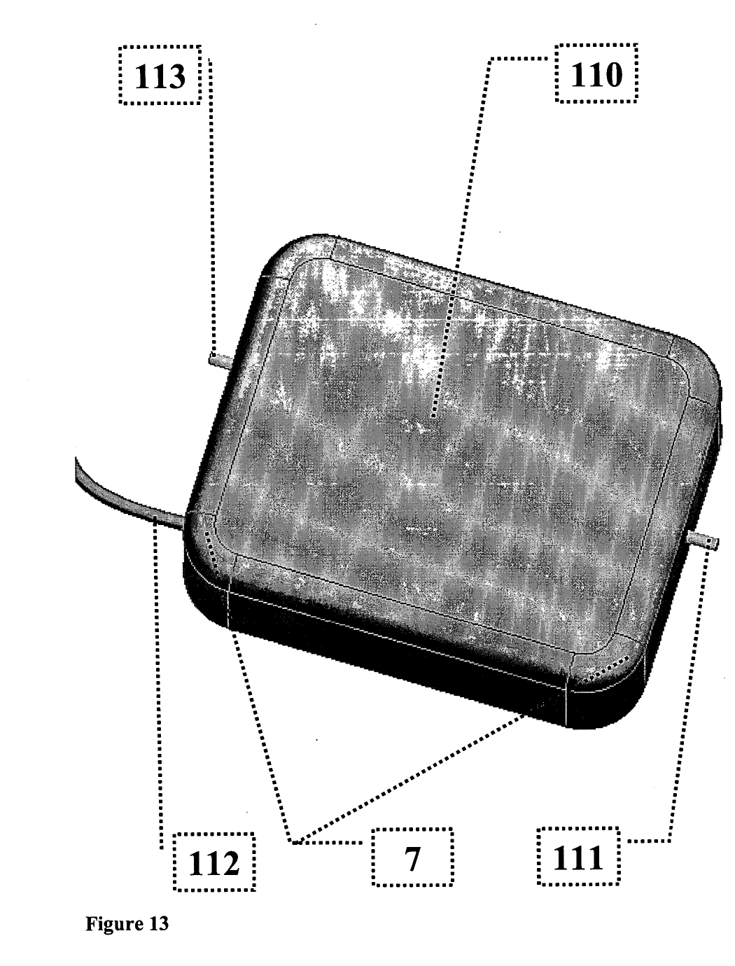

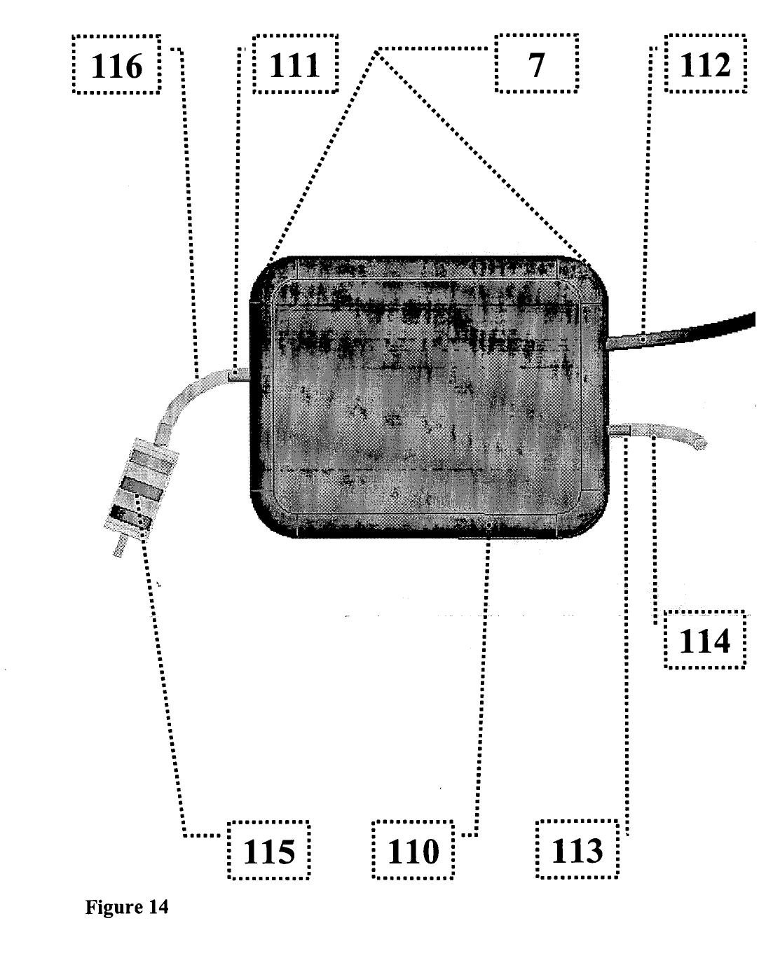

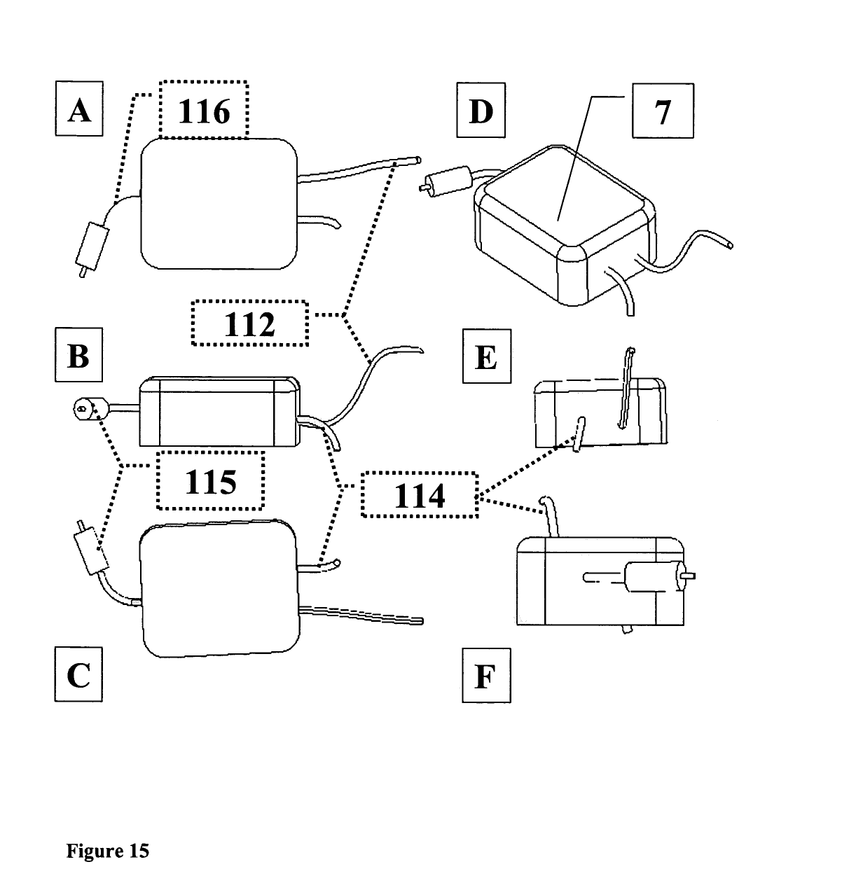

As it is depicted in FIGS. 14, 15 (Drawing sheet 14, 15), the ventilation system is composed of an air pump assembly 7, tubing system 114, 116, air filter assembly 115 and check valve assembly 136.

a. Air pump assembly: As it is depicted in FIG. 13 (Drawing sheet 13), the air pump assembly 7 is composed of a commercially available electrical air pump system (inside the air pump has not been shown), with a housing 7 and has one air inlet 113 and one air out let 111. The air inlet 113 is connected to a tubing structure 114 that is connected to said housing through housing lid or housing floor and permits the passage of air from housing interior 6 to air pump housing 7. The air outlet 111 is connected to a tubing structure 116 that is connected to the air inlet 120 of the air filter assembly 115 and permits the passage of air from air pump housing 7 to the air filter assembly 115. The electrical cord 112 connects air pump housing to the electricity wall outlet.

b. Tubing system: As it is depicted in FIGS. 14, 15 (Drawing sheet 14, 15), the tubing system are composed of two tubing structure 114, 116. Air flows from inside of the housing 6 to air inlet 113 of air pump 7 through a tubing structure 114. The air then flows from the air outlet 111 of the air pump 7 to air inlet 120 of the air filter assembly 115 through another tubing structure 116.

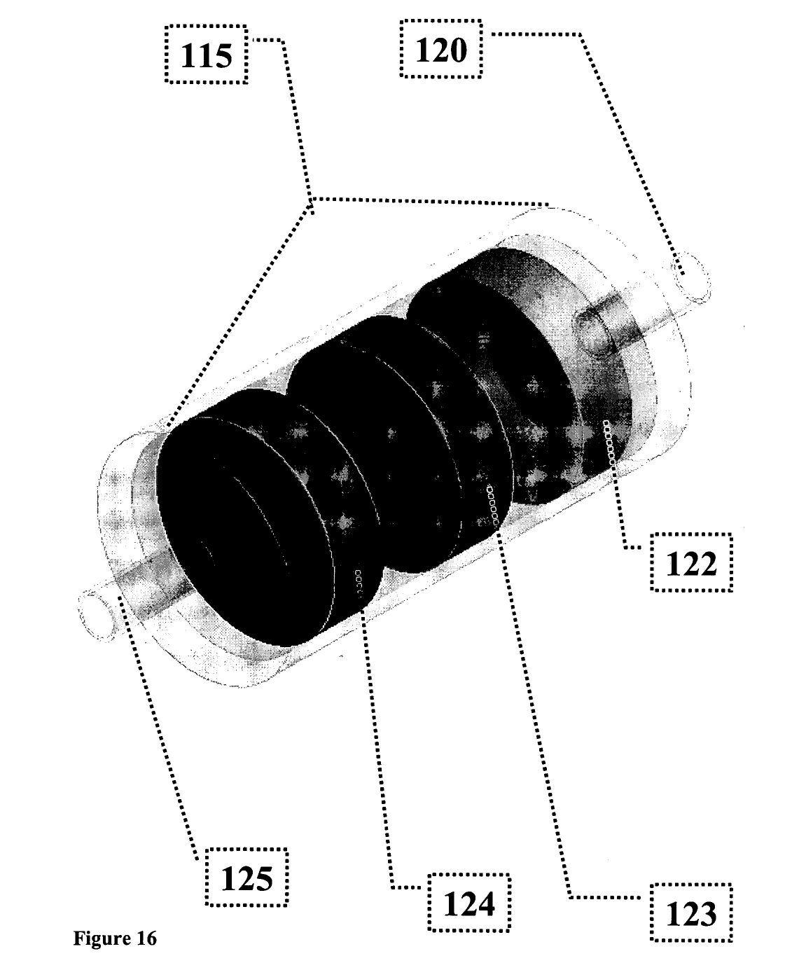

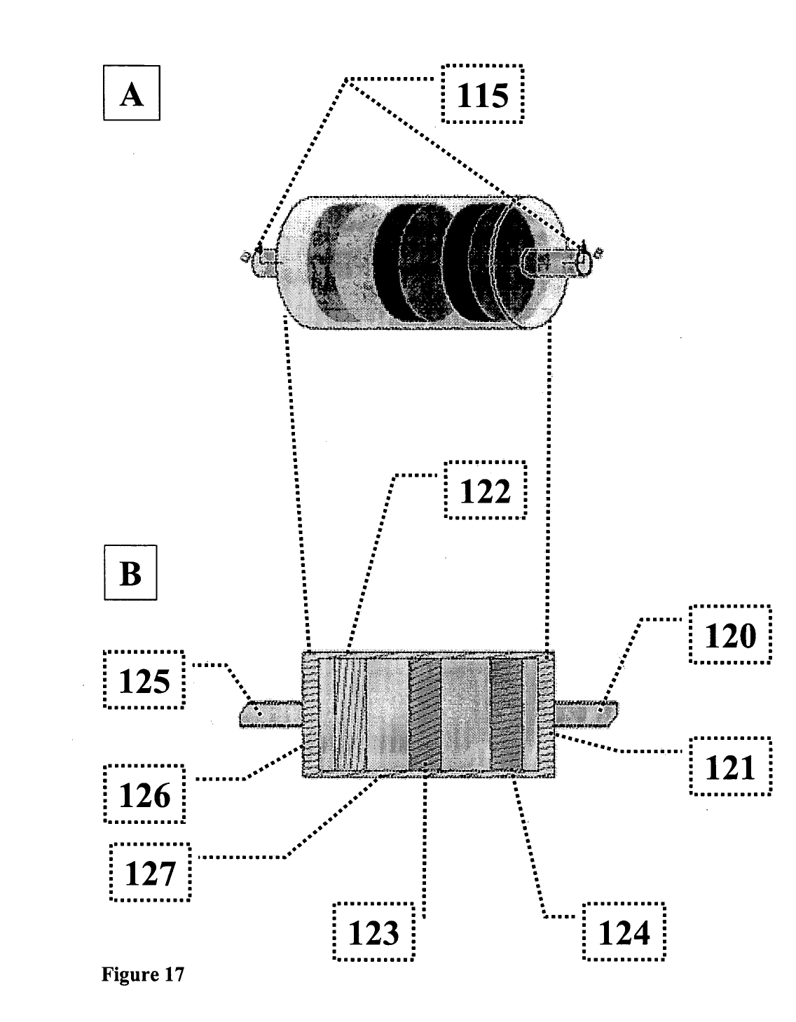

c. Air filter assembly: As it is depicted in FIGS. 16, 17 (Drawing sheet 16, 17), air filter assembly 115 is composed of a cylindrical housing 127 with two ends 121, 126. There is an air inlet 120 on one end 121 and an air outlet 125 on the other end 126. Inside the air filter housing, there are pluralities of air filter pads 122, 123, 124 that are circular and are placed in parallel position. These air filter pads 122, 123, 124 are same size and are shaped by a circular cut of various commercially available air filter materials. The air filter pads are designed to absorb dusts, fumes, microbes or allergens based on their substances and thus, eliminate a specific particle from the air that pass through them. As mentioned above, air that exits housing interior 6 enters said air pump assembly 7 and after exiting said air pump assembly 7, enters said air filter assembly 115, passes through pluralities of air filter pads 122, 123, 124 and eventually exits into surrounding environment.

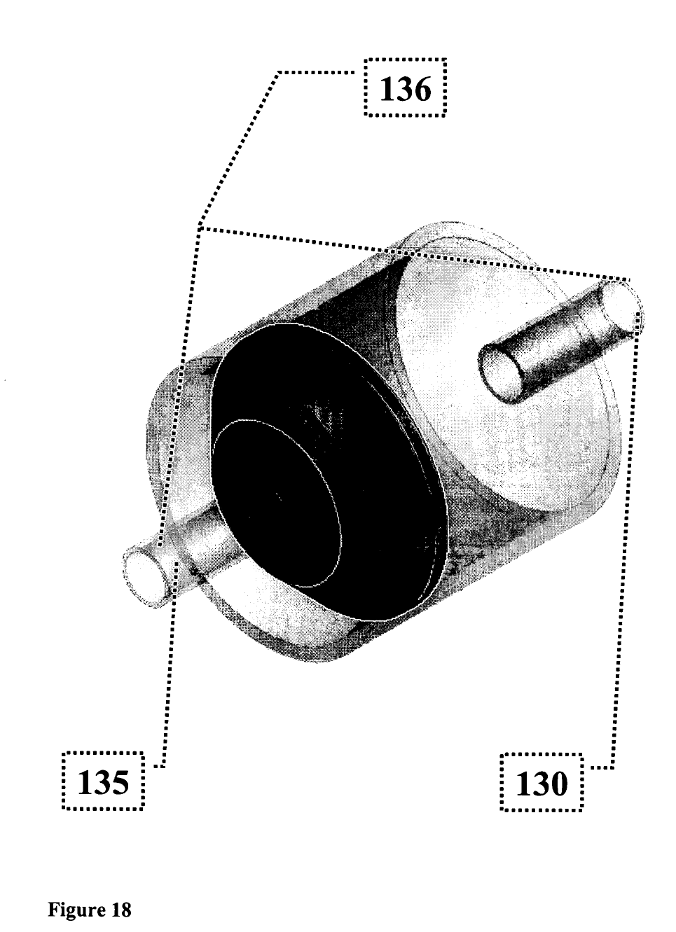

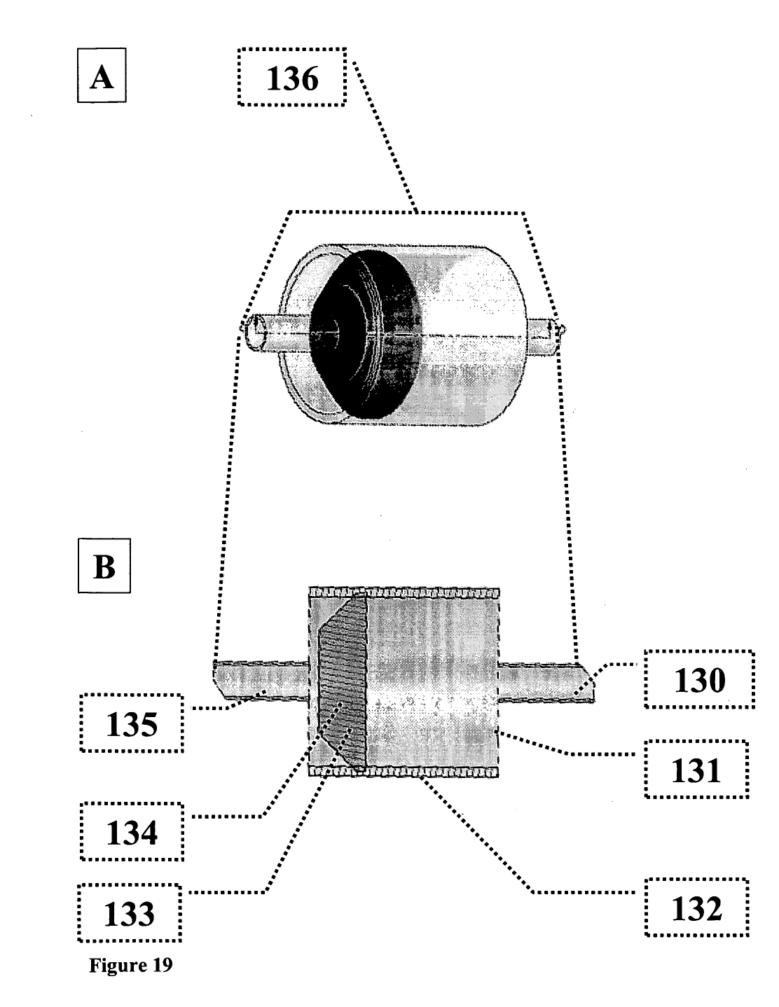

d. Check valve assembly: As it is depicted in FIGS. 18, 19 (Drawing sheet 18, 19), Check valve assembly 136 is composed of a cylindrical housing 132 with two ends 131, 134. There is an air inlet 135 on one end 134 and an air outlet 130 on the other end 131. Inside of said check valve housing 132, there is a one way rubber valve 133 that only permits passage of air from air inlet 135 toward air outlet 130. The Check valve assembly 136 is placed on top of the housing lid or beneath the housing floor and permits air to flow from surrounding environment into the housing interior 6 and prevents any air flow in opposite direction. This Check valve assembly 136 is commercially available.

C—Lighting Assembly

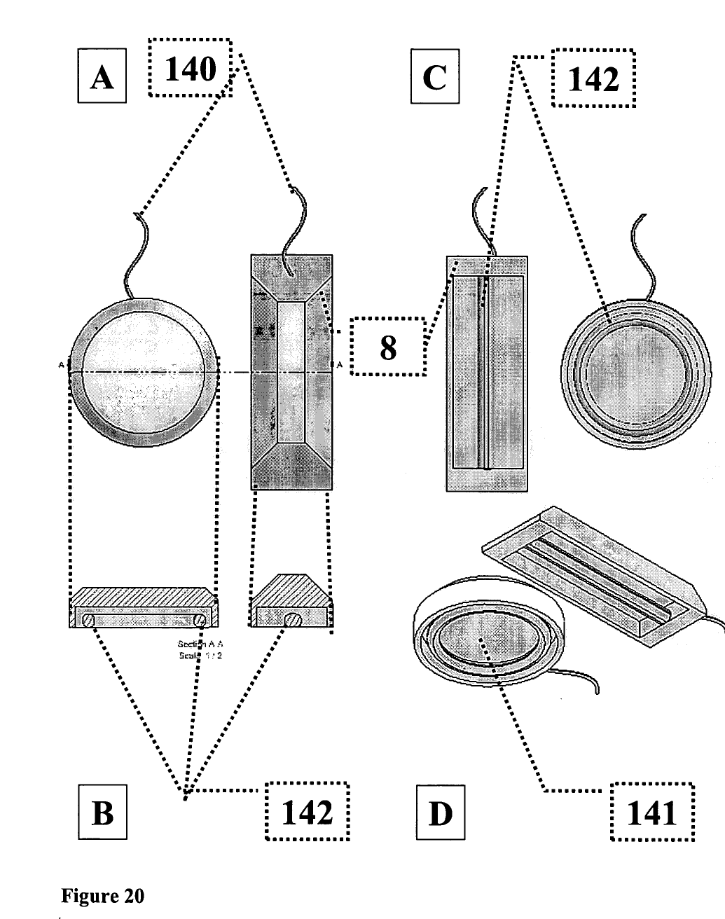

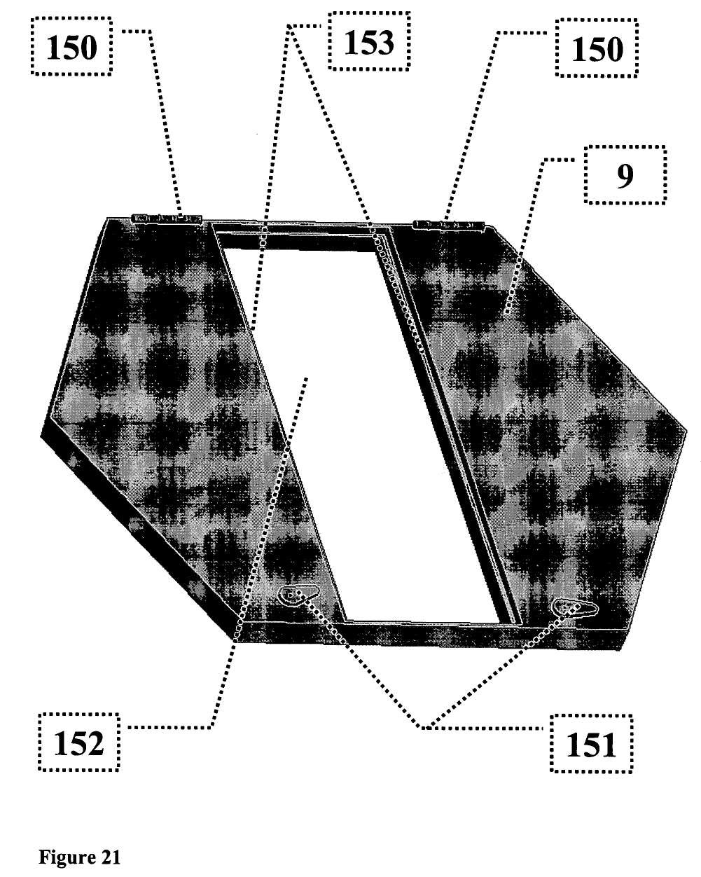

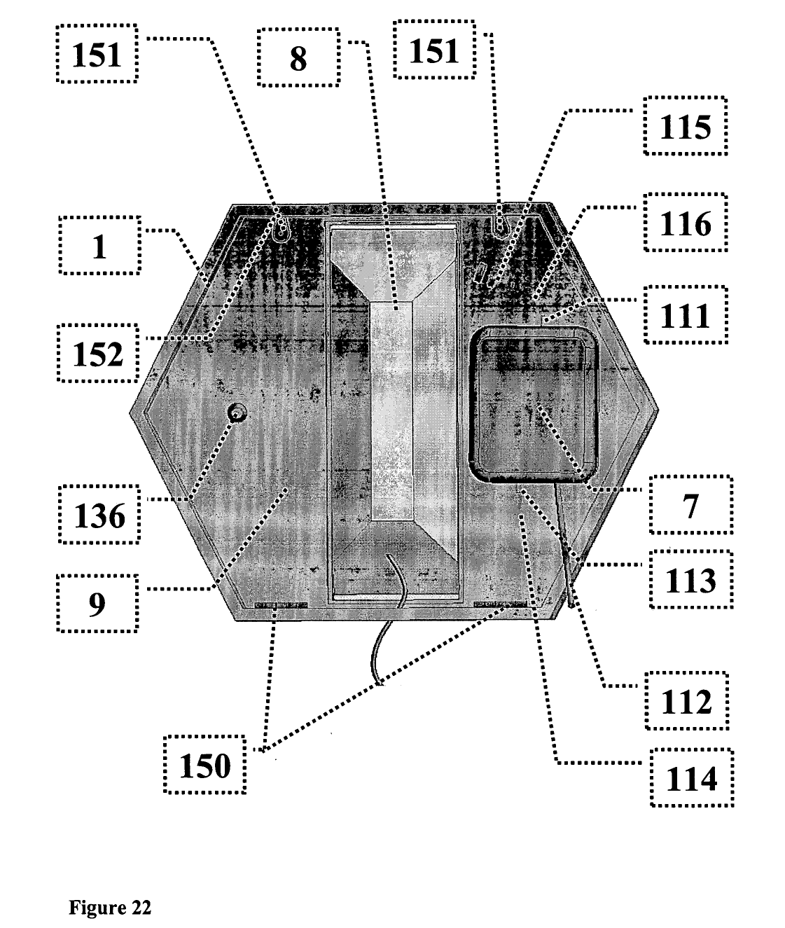

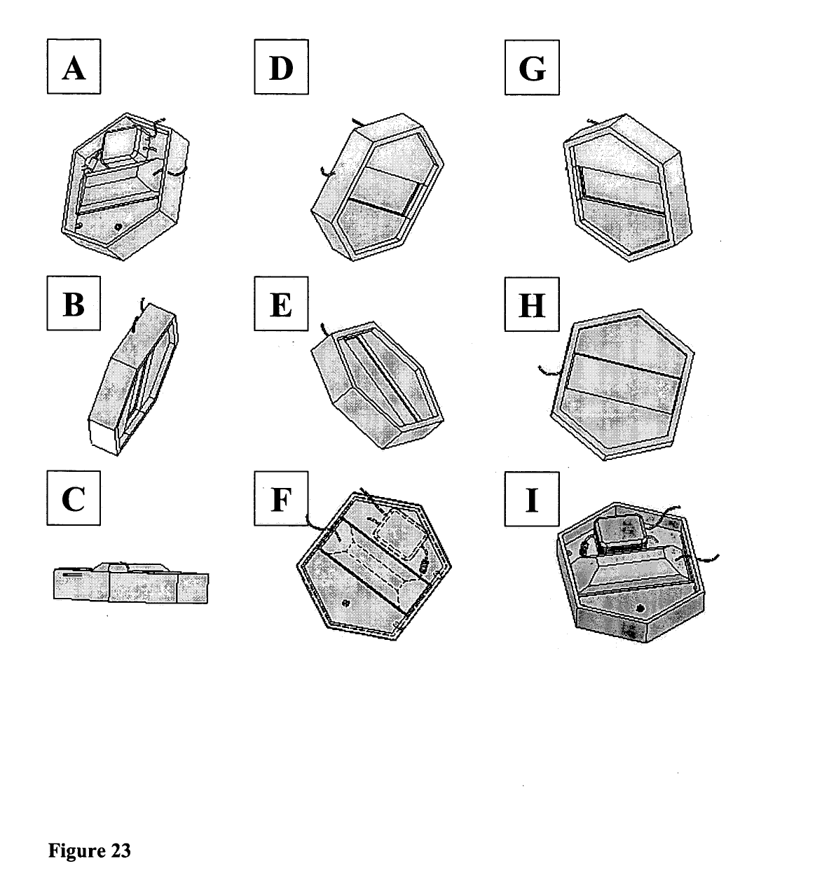

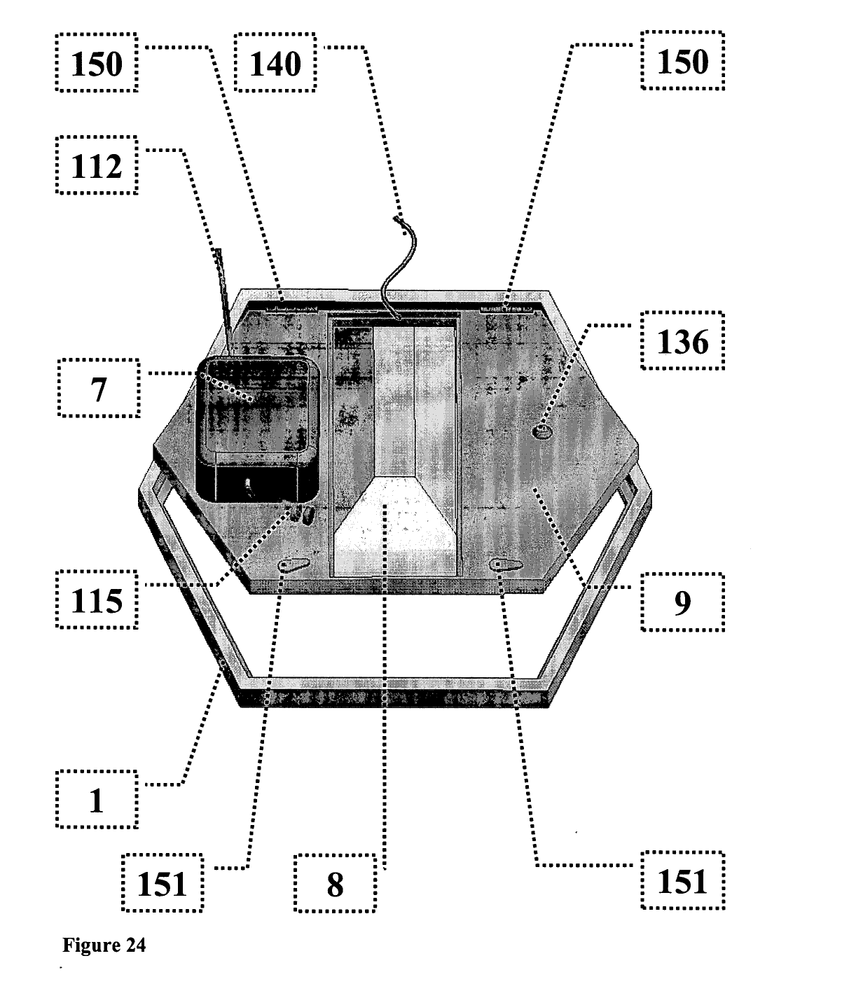

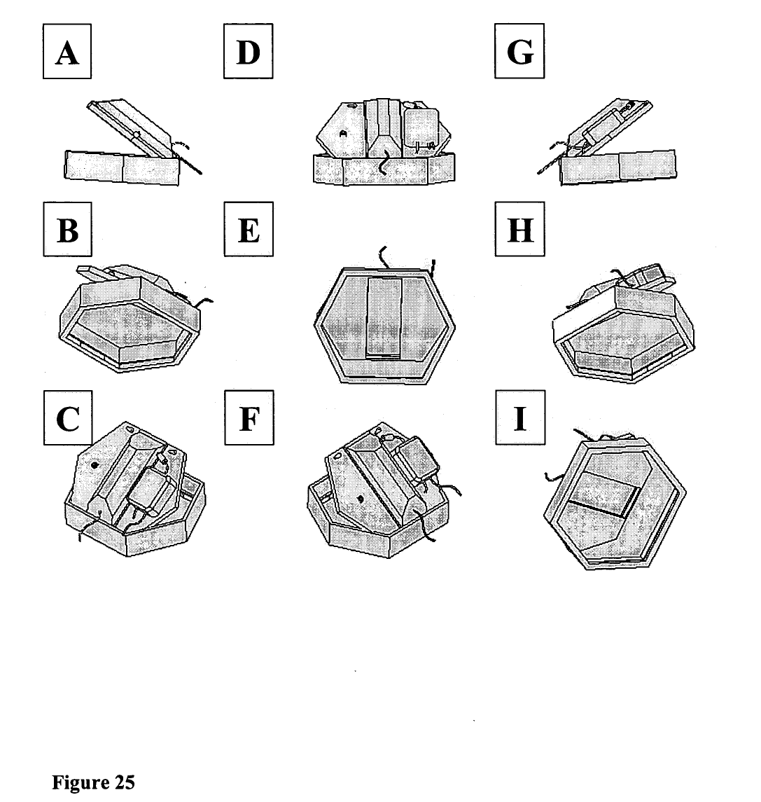

As it is depicted in FIG. 20 (Drawing sheet 20), the lighting assembly is composed of a casing 8, 141, electrical lamp 142 and an electrical cord 140. Depending on the format of the housing the lighting assembly casing 8, 141 has different shape. Said lighting assembly casing could have either circular 141 or rectangular 8 cross sections. The circular type 141 could accommodate the glass portion of the housing lid 15, 36, 86, 106 of cubical (FIG. 3), cylindrical (FIG. 5), mixed conical and cylindrical (FIG. 10) and curved cylindrical housings (FIG. 12). The circular type 141 could also accommodate the glass portion of housing floor 46, 66, 76, 96 of dome-shaped (FIG. 6), spherical (FIG. 8), pyramidal (FIG. 9) and conical housings (FIG. 11). Said rectangular lighting assembly casing 8 could accommodate the glass portion of the housing lid 152, 25, 56 of hexagonal prism (FIGS. 1-2), rectangular prism (FIG. 4) and triangular prism housings (FIG. 7). Inside of the lighting assembly casing 8, 141, the electrical lamp 142 could be any type of electrical lamps 142 including but not limited to fluorescent lamps. The lighting assembly is commercially available.

1. Container and display for potted plants and cut flowers or flower arrangements comprising:
a housing, which separates the potted plant, cut flowers, or flower arrangements from surrounding environment and the structure of said housing, is configured to produce an air-tight sealed environment inside of said housing when the housing lid is closed said housing comprising:
a plurality of walls defining a compartment being configured to contain removably positionable potted plants, cut flowers, or flower arrangements. Said walls are made in part or completely from transparent material including but not limited to glass, acrylic or other artifact, to make it possible to see enclosed potted plants or flowers inside the said housing. The said walls are surrounded on top and bottom part of the said housing by upper and lower housing frame to increase the stability of said housing.
a housing floor that potted plant, cut flowers, or flower arrangement could removably be placed on said floor inside of said housing. Said floor is made in part from transparent material including but not limited to glass, plastic or combination of these artifacts. The transparent portion of the said lid permits to illuminate inside of the said housing using lighting source beneath said floor.
a housing lid means for accessing said plant inside the housing. Said lid is positioned on top of side housing and could move using 2 or more hinge joints. The said hinge joints connect the moving lid to fixed part of the housing including but not limited to the upper frame or side walls of said housing. The potted plants, cut flowers, or flower arrangements could removably be positioned inside of the housing when said housing lid is open. Said housing is completely air-tight sealed when said lid is closed. Said lid is made in part from transparent material including but not limited to glass, plastic or combination of these artifacts. The transparent portion of the said lid permits to illuminate inside of the said housing using an external lighting source on top of said lid.
a lighting assembly means for illuminating inside of said housing by an artificial light source from inside or outside of the housing. Said light source could be positioned out side of said housing on side walls, beneath said transparent housing floor or above said transparent housing lid or inside of the said housing.
a decorative stand for placing of said housing for display. Said stand is for decorative purpose and could be an optional component.
a ventilating assembly means that is the only source for exchanging air between outside of said housing and inside of said housing for plant respiration, comprising:
an electrical air pump wherein said air pump could be positioned inside of the said housing or outside of the said housing on top of said housing lid or beneath said housing floor and said air pump blow the said housing air through plurality of air filters disposed in an air filter assembly.
an air filter assembly where it is composed of small closed housing with one air inlet and one air outlet in each side and disposed within, plurality of air filter pads that clear-up air-borne particulate materials including but not limited to dusts, fumes, allergens and microbes.
plurality of tubing for connecting said air pump to said housing and said air pump to said air filter assembly
a check valve that ensure that air flows into said housing and prevents backflow of air into external environment (outside of said housing).

2. The housing of claim 1 wherein said housing could be made in any three dimensional shapes including but not limited to hexagonal prism, octagonal prism, triangular prism, cube, rectangular prism, cylinder, dome, sphere, cone, pyramid, diamond, mixed cone & cylinder, curved cylinder or any mixture of these shapes.
The housing of claim 1 wherein the size of said housing depends on the size of the potted plants.
The housing of claim 1 wherein the housing in the format of dome, sphere, cone, pyramid, diamond or any mixture differ from the housing in the format of hexagonal prism, octagonal prism, triangular prism, cube, rectangular prism, cylinder, diamond, mixed cone & cylinder and curved cylinder. The differences include:
absence of said removable lid in claim 1 for accessing inside of said housing in the former group.
Removable wall/s, which is part of housing and permits access to said housing inside without need for said housing lid. Said removable wall is in the form of dome in the dome-shaped housing, partial sphere in spherical housing, cone in conical housing, pyramid in pyramidal housing, or diamond in diamond-shaped housing. Said wall is removably positioned on said housing floor. The potted plants, cut flowers, or flower arrangements could removably be positioned inside of the housing when said housing wall is removed. Said housing is completely air-tight sealed when said wall is securely positioned in a grove on said housing floor that accommodate the removable said wall. Said wall is made in part or completely from transparent material including but not limited to glass, acrylic or other artifact, to make it possible to see enclosed potted plants or flowers.
A housing floor that potted plant, cut flowers, or flower arrangement could removably be placed on said floor inside of said housing. Said floor is made in part from transparent material including but not limited to glass, plastic or combination of these artifacts. The transparent portion of the said lid permits to illuminate inside of the said housing using an external lighting source beneath said floor. Said floor has a groove that accommodates the said removable wall.
A lighting assembly in claim 1 wherein said light assembly could be positioned beneath said housing floor of said housing.
A ventilating assembly in claim 1 wherein said assembly could be placed under the said housing floor.

3. The air filter assembly in claim 1 wherein the said filter assembly is:
easily replaceable and disposable.
containing synthetic filter pad to absorb and eliminate microbes, fungus spores, bacteria and other small microbes from ventilated air, carbon filter pad to absorb and eliminate odors or chemical fumes from ventilated air and special synthetic filter to absorb and eliminate allergens and dusts from ventilated air.
